(19) United States
(12) Patent Application Publication
(10) Pub. No.: US 2013/0303376 A1
(43) Pub. Date: Nov. 14, 2013

(54) METHODS OF IMPROVING PLANT GROWTH

(71) Applicant: Bayer CropScience AG, Monheim (DE)

(72) Inventors: Robert Velten, Langenfeld (DE); Peter Jeschke, Bergisch Gladbach (DE); Dirk Ebbinghaus, Wuppertal (DE); Wolfgang Thielert, Odenthal (DE); Heike Hungenberg, Langenfeld (DE); Claudia Urlass, Leverkusen (DE)

(21) Appl. No.: 13/946,563

(22) Filed: Jul. 19, 2013

Related U.S. Application Data
(62) Division of application No. 12/680,849, filed on Jul. 19, 2010.

(30) Foreign Application Priority Data
Oct. 2, 2007 (EP) 07117758.8
Feb. 12, 2008 (EP) 08151308.7

(51) Int. Cl. A01N 43/40

(52) U.S. Cl. CPC A01N 43/40
USPC 504/251; 546/284.4; 504/244; 546/334

(57) ABSTRACT

The invention relates to the use of at least one compound selected from the class of the enaminocarbonyl compounds for enhancing plants' intrinsic defences and/or for improving plant growth and/or for enhancing the resistance of plants to plant diseases which are caused by fungi, bacteria, viruses, MLOs (mycoplasma-like organisms) and/or RLOs (rickettsia-like organisms), and/or for enhancing the resistance of plants to abiotic stress factors.

### CROSS REFERENCE TO RELATED APPLICATIONS

This application is a Divisional Application of U.S. application Ser. No. 12/680,849, filed Jul. 19, 2010, which is a §371 National Stage Application of PCT/EP2008/007857, filed Sep. 19, 2008, which claims priority to European Application No. 07117758.8, filed Oct. 2, 2007, and European Application No. 08151308.7, filed Feb. 12, 2008, the content of all of which are incorporated herein by reference in their entireties.

### BACKGROUND OF THE INVENTION

1. Field of the Invention

The invention relates to methods which, using enaminocarbonyl compounds, are suitable for enhancing plants' intrinsic defences and/or for improving plant growth and/or for increasing the resistance of plants to plant diseases which are caused by fungi, bacteria, viruses, MLOs (mycoplasma-like organisms) and/or RLOs (rickettsia-like organisms).

2. Description of Related Art

It is known that plants react to natural stress conditions such as, for example, cold, heat, drought, wounding, pathogen attack (viruses, bacteria, fungi), insects and the like, but also to herbicides, with specific or unspecific defence mechanisms (Pflanzenbiochemie, p. 393-462, Spektrum Akademischer Verlag, Heidelberg, Berlin, Oxford, Hans W. Heldt, 1996; Biochemistry and Molecular Biology of Plants, p. 1102-1203, American Society of Plant Physiologists, Rockville, Md., eds. Buchanan, Gruissem, Jones, 2000). In this context, signal substances, for example cell wall constituents which have been generated by wounding, or specific signal substances which originate from the pathogen, act as inductors of plant signal transduction chains which eventually lead to the formation of defence molecules directed against the stress factor. They can take the form of, for example, (a) low-molecular weight substances such as, for example, phytoalexins, (b) nonenzymatic proteins such as, for example, pathogen-related proteins (PR proteins), (c) enzymatic proteins such as, for example, chitinases, glucanases, or (d) specific inhibitors of essential proteins such as, for example, protease inhibitors, xylanase inhibitors, which directly attack the pathogen or interfere with its proliferation (Dangl and Jones, Nature 411, 826-833, 2001; Kessler and Baldwin, Annual Review of Plant Biology, 53, 299-328, 2003).

An additional defence mechanism is what is known as the hypersensitive reaction (HR), which is mediated by oxidative stress and which leads to the death of plant tissue around an infection focus, thus preventing the spreading of plant pathogens which depend on live cells (Pennazio, New Microbiol. 18, 229-240, 1995).

In the further course of an infection, signals are transmitted, by plant messenger substances, into noninfected tissue, where, again, they result in defence reactions being triggered, and interfere with the development of secondary infections (systemic acquired resistance, SAR) (Ryals et al., The Plant Cell 8, 1809-1819, 1996).

A series of endogenous plant signal substances which are involved in stress tolerance or pathogen defence are already known. The following may be mentioned: salicylic acid, benzoic acid, jasmonic acid or ethylene (Biochemistry and Molecular Biology of Plants, pp. 850-929, American Society of Plant Physiologists, Rockville, Md., eds. Buchanan, Gruissem, Jones, 2000). Some of these substances or their stable synthetic derivatives and derived structures are also effective when applied externally to plants, or as seed dressing, and activate defence reactions which result in an enhanced stress or pathogen tolerance of the plant (Sembdner, Parthier. Ann. Rev. Plant Physiol. Plant Mol. Biol. 44, 569-589, 1993). The salicylate-mediated defence is directed especially against phytopathogenic fungi, bacteria and viruses (Ryals et al., The Plant Cell 8, 1809-1819, 1996).

A known synthetic product with an action comparable to that of salicylic acid, and which is capable of exerting a protective effect against phytopathogenic fungi, bacteria and viruses, is benzothiadiazole (CGA 245704; common name: Acibenzolar-S-methyl; trade name: Bion®) (Achuo et al., Plant Pathology 53 (1), 65-72, 2004; Tamblyn et al., Pesticide Science 55 (6), 676-677, 1999; EP-OS 0 313 512).

Other compounds which belong to the group of the oxylipins such as, for example, jasmonic acid, and the protective mechanisms which they trigger, are especially active against harmful insects (Walling, J. Plant Growth Regul. 19, 195-216, 2000).

It is furthermore known that the treatment of plants with insecticides from the neonicotinoid (chloronicotinyl) series leads to increased resistance of the plant to abiotic stress. This applies, in particular, to the substance imidacloprid (Brown et al., Beltwide Cotton Conference Proceedings 2231-2237, 2004). This protection is generated by the physicological and biochemical properties of the plant cells being affected, such as, for example, by improving membrane stability, increasing the carbohydrate concentration, enhancing the polyol concentration and antioxidant activity (Gonias et al., Beltwide Cotton Conference Proceedings 2225-2229, 2004).

The effect of chloronicotinyls against biotic stress factors is furthermore known (Crop Protection 19 (5), 349-354, 2000; Journal of Entomological Science 37(1), 101-112, 2002; Annals of Biology (Hisar, India) 19 (2), 179-181, 2003). For example, insecticides from the neonicotinoid (chloronicotinyl) series lead to the enhanced expression of genes from the series of the pathogenesis-related proteins (PR proteins). PR proteins support the plants primarily in the defence against biotic stress factors, such as, for example, phytopathogenic fungi, bacteria and viruses (DE 10 2005 045 174 A; DE 10 2005 022 994 A and WO 2006/122662 A; Thielert Pflanzenschutz-Nachrichten Bayer, 59 (1), 73-86, 2006).

It is furthermore known that the treatment of genetically modified plants with insecticides from the neonicotinoid (chloronicotinyl) series leads to an improved stress tolerance of the plant (EP 1 731 037 A), for example also to the herbicide glyphosate (WO 2006/015697 A).

Thus, it is known that plants have available a plurality of endogenous reaction mechanisms which may bring about an effective defence against a wide range of harmful organisms (biotic stress) and/or abiotic stress.

Cultivating healthy and uniformly grown seedlings is an essential prerequisite for the large-scale production and the economical management of agricultural, horiticultural and silvicultural crop plants.

A large number of cultivation methods for seedlings are established in agriculture, forestry and horticulture. Cultivation media which are used here are, besides steam soil, also specific media, among which media based on white peat, coconut fibres, rockwool such as, for example, Grodan®, pumice, expanded clay such as, for example, Lecaton® or Lecadan®, clay granules such as, for example. Seramis®, foams, such as, for example, Baystrat®, vermiculites, pearlites, artificial soils, such as, for example, Hygromull® or combinations of these media, into which either fungi- and/or insecticide-treated or else untreated seed is sown.

In special crops such as, for example, tobacco, young plants are increasingly grown by what is known as the float method or floating method (Leal, R. S., The use of Confidor S in the float, a new tobacco seedlings production system in the South of Brazil. Pflanzenschutz-Nachrichten Bayer (German edition) (2001), 54(3), pages 337 to 352; Rudolph, R. D.; Rogers, W. D.; The efficacy of imidacloprid treatment for reduction in the severity of insect vectored virus diseases of tobacco. Pflanzenschutz-Nachrichten Bayer (German edition) (2001), 54(3), pages 311 to 336). In this method, the seed is sown into specific containers, for example perforated Styropor trays, in specific, peat-medium-based compost, and subsequently cultured in containers with a suitable nutrient solution until the seedlings have reached the desired transplant size (FIG. 1). Here, the containers are allowed to float on the nutrient solution, which gives the cultivation method its name (Leal, 2001, see above). In floating methods, insecticides from the neonicotinoid (chloronicotinyl) class have been employed for some years for controlling sucking pests. In the float method, the plants are usually sprayed with neonicotinoid (chloronicotinyl) insecticides shortly before transplanting, or drenched with neonicotinoid (chloronicotinyl) insecticides immediately before or during transplanting in the field (Leal, 2001, see above; Rudolph and Rogers, 2001, see above). Both application methods are technically relatively complicated.

Here, fungicides and insecticides are used up to the transplantation in order to protect the emerging generative or vegetative propagation material from fungal pathogens and pests. The choice of the plant protection products, the site and timing of application, and the application rate of the compositions depends in this context mainly on the type of the fungal diseases and pests which are encountered, the specific mode of action and duration of action of the compositions and on the plant tolerance, and can thus be adapted directly to the specific requirements of a variety of crops and regions.

Enaminocarbonyl compounds have been described for example as agents for controlling animal pests, in particular insects, and they can be prepared by customary methods (for example EP 0 539 588 A, WO 2006/037475 A, WO 2007/115643, WO 2007/115644 and WO 2007/115646). Moreover, the enhanced insecticidal activity by means of adding suitable salts and, if appropriate, additives has been described for individual enaminocarbonyl compounds (WO 2007/068355).

It is not known from the prior art that enaminocarbonyl compounds are active against biotic stress factors and/or abiotic stress of plants, or with regard to plant growth.

It has now been found that enaminocarbonyl compounds are suitable for enhancing the plants' intrinsic defences (pathogen defence in plants).

Here, the enaminocarbonyl compounds result in a good protection of the plants from the damage by fungal, bacterial or viral pathogens, independently of a control of insects. Without wanting to be bound by theory, it is currently assumed that the defence against the pathogens is the result of the induction of PR proteins as a consequence of the treatment with at least one enaminocarbonyl compound.

### SUMMARY

The use according to the invention shows the above-described advantages in particular in the treatment of seed, of the soil, in specific cultivation and growing methods (for example floating box, rockwool, hydroponics), but also in the treatment of stems and leaves. Combinations of enaminocarbonyl compounds with, inter alia, insecticides, fungicides and bactericides show a synergistic effect on the control of plant diseases. The combined use of enaminocarbonyl compounds together with genetically modified varieties with regard to an elevated abiotic stress tolerance additionally leads to a synergistically improved growth.

Finally, it has also been found in accordance with the invention that enaminocarbonyl compounds are suitable not only for enhancing pathogen defence in plants, but also for improving plant growth and/or for enhancing the resistance of plants to plant diseases which are caused by fungi, bacteria, viruses, MLOs (mycoplasma-like organisms) and/or RLOs (rickettsia-like organisms), in particular to soil-borne fungal diseases, and/or for increasing the resistance of plants to abiotic stress factors.

The abiotic stress factors may include, for example, drought, cold and heat conditions, osmotic stress, waterlogging, increased soil salinity, increased exposure to minerals, ozone conditions, strong light conditions, limited availability of nitrogen nutrients, limited availability of phosphorus nutrients or the avoidance of shade.

### BRIEF DESCRIPTION OF THE DRAWINGS

FIGS. 1-6 represent embodiments described herein.

### BRIEF DESCRIPTION OF A PREFERRED EMBODIMENT

The present invention therefore firstly relates to the use of at least one compound selected from the class of the enaminocarbonyl compounds for enhancing plants' intrinsic defences and/or for improving plant growth and/or for enhancing the resistance of plants to plant diseases which are caused by fungi, bacteria, viruses, MLOs (mycoplasma-like organisms) and/or RLOs (rickettsia-like organisms), in particular to soil-borne fungal diseases, and/or for enhancing the resistance of plants to abiotic stress factors.

Especially suitable enaminocarbonyl compounds are described by the general formula (I):

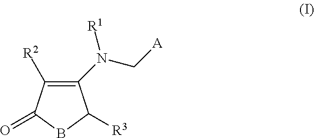

in which
A represents pyrid-2-yl or pyrid-4-yl or represents pyrid-3-yl which is optionally substituted in the 6-position by fluorine, chlorine, bromine, methyl, trifluoromethyl or trifluoromethoxy, or represents pyridazin-3-yl which is optionally substituted in the 6-position by chlorine or methyl, or represents pyrazin-3-yl, or represents 2-chloropyrazin-5-yl or represents 1,3-thiazol-5-yl which is optionally substituted in the 2-position by chlorine or methyl, or
A represents a radical pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl, which radical is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulphonyl (which is optionally substituted by fluorine and/or chlorine),
or
A represents a radical

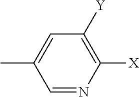

in which
X represents halogen, alkyl or haloalkyl,
Y represents halogen, alkyl, haloalkyl, haloalkoxy, azido or cyano,
B represents oxygen, sulphur, ethylene or methylene,
R¹ represents hydrogen, alkyl, haloalkyl, alkenyl, haloalkenyl, alkynyl, cycloalkyl, cycloalkylalkyl, halocycloalkyl, alkoxy or halocycloalkylalkyl,
R² represents hydrogen or halogen and
R³ represents hydrogen or alkyl.

Preferred, especially preferred and very especially preferred substituents or ranges of the radicals detailed in the abovementioned formula (I) are explained hereinbelow.
A preferably represents 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl, 2-chloropyrimidin-5-yl, 2-trifluoromethylpyrimidin-5-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chlompyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl.
B preferably represents oxygen or methylene.
R¹ preferably represents optionally fluorine-substituted C₁-C₅-alkyl, C₂-C₈-alkenyl, C₃-C₈-cycloalkyl, C₁-C₈-cycloalkylalkyl or C₁-C₈-alkoxy.
R² preferably represents hydrogen or halogen.
R³ preferably represents in each case hydrogen or methyl.
A especially preferably represents the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl, 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl.
B especially preferably represents oxygen or methylene.
R¹ especially preferably represents methyl, ethyl, propyl, vinyl, allyl, propargyl, cyclopropyl, 2-fluoroethyl, 22-difluoroethyl, 2-fluorocyclopropyl or methoxy.
R² especially preferably represents hydrogen, fluorine or chlorine.
R³ especially preferably represents hydrogen.
B very especially preferably represents oxygen.
A very especially preferably represents the radical 6-chloropyrid-3-yl, 6-bromopyrid-3-yl, or 6-chloro-1,4-pyridazin-3-yl, 5-fluoro-6-chloropyrid-3-yl or 5-fluoro-6-bromopyrid-3-yl.
R¹ very especially preferably represents methyl, ethyl, n-propyl, n-prop-2-enyl, n-prop-2-ynyl, cyclopropyl, 2-fluoroethyl or 2,2-difluoroethyl.
R² very especially preferably represents hydrogen.
R³ very especially preferably represents hydrogen.

In an emphasized group of compounds of the formula (I), A represents 6-fluoropyrid-3-yl

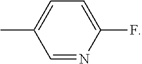

In an emphasized group of compounds of the formula (I), A represents 6-chloropyrid-3-yl

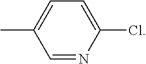

In a further emphasized group of compounds of the formula (I), A represents 6-bromopyrid-3-yl

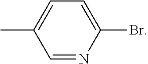

In a further emphasized group of compounds of the formula (I), A represents 6-trifluoromethylpyrid-3-yl

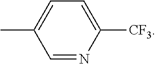

In a further emphasized group of compounds of the formula (I), A represents 6-chloro-1,4-pyridazin-3-yl

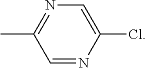

In a further emphasized group of compounds of the formula (I), A represents 2-chloro-1,3-thiazol-5-yl

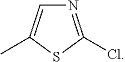

The following text defines a further group of preferred compounds of the formula (I), in which
A represents pyrid-3-yl which is substituted in the 6-position by fluorine, chlorine, bromine, methyl or trifluoromethyl, or represents 2-chloropyrazin-5-yl or 2-chloro-1,3-thiazol-5-yl,
B represents oxygen, sulphur or methylene,
R¹ represents halo-C₁₋₃-alkyl, halo-C₂₋₃-alkenyl, halocyclopropyl (where halo represents, in particular, fluorine or chlorine),
R² represents hydrogen or halogen,
R³ represents hydrogen or methyl,
A preferably represents 6-fluoropyrid-3-yl, 6-chloropyrid-3-yl, 6-bromopyrid-3-yl, 6-trifluoromethylpyrid-3-yl, 2-chloropyrazin-5-yl or 2-chloro-1,3-thiazol-5-yl,
B preferably represents oxygen or methylene,
R¹ preferably represents difluoromethyl, 2-fluoroethyl, 2,2-difluoroethyl, 2-chloro-2-fluoroethyl, 3-fluoro-n-propyl, 2-fluorovinyl, 3,3-difluoroprop-2-enyl or 3,3-dichloroprop-2-enyl,
R² preferably represents hydrogen or halogen (where halogen represents, in particular, fluorine or chlorine),
R³ preferably in each case represents hydrogen,
A especially preferably represents the radical 6-chloropyrid-3-yl or 6-bromopyrid-3-yl,
B especially preferably represents oxygen,
R¹ especially preferably represents 2-fluoroethyl or 2,2-difluoroethyl,
R² especially preferably represents hydrogen.
R³ especially preferably in each case represents hydrogen,
A very especially preferably represents the radical 6-chloropyrid-3-yl or 6-bromopyrid-3-yl.
B very especially preferably represents oxygen,
R¹ very especially preferably represents 2,2-difluoroethyl,
R¹ very especially preferably represents hydrogen and
R³ very especially preferably in each case represents hydrogen.

In a further emphasized group of compounds of the formula (I), R³ represents hydrogen, B represents oxygen and A represents 6-chloropyrid-3-yl

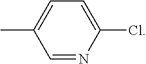

In a further emphasized group of compounds of the formula (I), R³ represents hydrogen, B represents oxygen and A represents 6-bromopyrid-3-yl

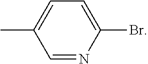

In a further emphasized group of compounds of the formula (I), R³ represents hydrogen, B represents oxygen and A represents 6-fluoropyrid-3-yl

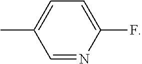

In a further emphasized group of compounds of the formula (I), R³ represents hydrogen, B represents oxygen and A represents 6-trifluoromethylpyrid-3-yl

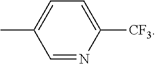

In a further emphasized group of compounds of the formula (I), R³ represents hydrogen, B represents oxygen and A represents 2-chloro-1,3-thiazol-5-yl

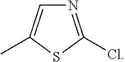

In a further emphasized group of compounds of the formula (I), R² and R³ represent hydrogen, B represents oxygen and A represents 6-chloropyrid-3-yl

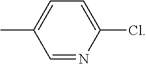

In a further emphasized group of compounds of the formula (I), R² and R³ represent hydrogen, B represents oxygen and A represents 6-bromopyrid-3-yl

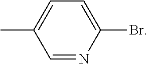

In a further emphasized group of compounds of the formula (I), R² and R³ represent hydrogen, B represents oxygen and A represents 6-fluoropyrid-3-yl

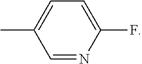

In a further emphasized group of compounds of the formula (I), R² and R³ represent hydrogen, B represents oxygen and A represents 6-trifluoromethylpyrid-3-yl

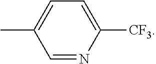

In a further emphasized group of compounds of the formula (I), R² and R³ represent hydrogen, B represents oxygen and A represents 2-chloro-1,3-thiazol-5-yl

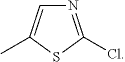

In a further emphasized group of compounds of the formula (I), R² and R³ represent hydrogen, B represents methylene and A represents 6-chloropyrid-3-yl

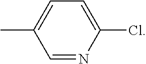

In a further emphasized group of compounds of the formula (I), R² and R³ represent hydrogen, B represents methylene and A represents 6-bromopyrid-3-yl

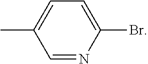

In a further emphasized group of compounds of the formula (I), R² and R³ represent hydrogen, B represents methylene and A represents 6-fluoropyrid-3-yl

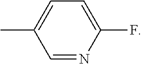

In a further emphasized group of compounds of the formula (I), R² and R³ represent hydrogen, B represents methylene and A represents 6-trifluoromethylpyrid-3-yl

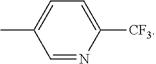

In a further emphasized group of compounds of the formula (I), R² and R³ represent hydrogen, B represents methylene and A represents 2-chloro-1,3-thiazol-5-yl

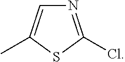

In a further emphasized group of compounds of the formula (I), R¹ represents difluoromethyl, R² and R³ represent hydrogen and B represents oxygen.

In a further emphasized group of compounds of the formula (I), R¹ represents 2-fluoroethyl, R² and R³ represent hydrogen and B represents oxygen.

In a further emphasized group of compounds of the formula (I), R¹ represents 2,2-difluoroethyl, R² and R³ represent hydrogen and B represents oxygen.

In a further emphasized group of compounds of the formula (I), R¹ represents difluoromethyl, R² and R³ represent hydrogen and B represents methylene.

In a further emphasized group of compounds of the formula (I), R¹ represents 2-fluoroethyl, R² and R³ represent hydrogen and B represents methylene.

In a further emphasized group of compounds of the formula (I), R¹ represents 2,2-difluoroethyl, R² and R¹ represent hydrogen and B represents methylene.

The definitions of radicals, or explanations, which have been detailed above, either in general or in preferred ranges, can be combined with one another as desired, that is to say combinations between the respective preferred ranges are also possible.

Compounds of the formula (I) which are preferred in accordance with the invention are those in which feature a combination of the meanings detailed above as being preferred.

Compounds of the formula (I) which are especially preferred in accordance with the invention are those in which feature a combination of the meanings detailed above as being especially preferred.

Compounds of the formula (I) which are very especially preferred in accordance with the invention are those in which feature a combination of the meanings detailed above as being very especially preferred.

A preferred subgroup of the enaminocarbonyl compounds according to the invention are those of the formula (I-a)

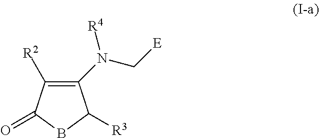

in which
E represents pyrid-2-yl or pyrid-4-yl, or represents pyrid-3-yl which is optionally substituted in the 6-position by fluorine, chlorine, bromine, methyl, trifluoromethyl or trifluoromethoxy, or represents pyridazin-3-yl which is optionally substituted in the 6-position by chlorine or methyl, or represents pyrazin-3-yl or represents 2-chloropyrazin-5-yl, or represents 1,3-thiazol-5-yl which is optionally substituted in the 2-position by chlorine or methyl,
R⁴ represents haloalkyl, haloalkenyl, halocycloalkyl or halocycloalkylalkyl,
and R², R³ and B have the abovementioned meanings.

Preferred substituents or ranges of the radicals detailed in the formula (I-a) mentioned hereinabove and hereinbelow are explained in the following text.
E preferably represents 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
B preferably represents oxygen or methylene.
R² preferably represents hydrogen or halogen (where halogen represents, in particular, fluorine or chlorine).
R³ preferably represents in each case hydrogen or methyl.
R⁴ preferably represents fluorine-substituted C₁-C₅-alkyl, C₂-C₅-alkenyl, C₃-C₅-cycloalkyl or C₃-C₅-cycloalkylalkyl.
E especially preferably represents the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl.
B especially preferably represents oxygen or methylene.
R² especially preferably represents hydrogen.
R³ especially preferably represents hydrogen.
R⁴ especially preferably represents 2-fluoroethyl, 2,2-difluoroethyl, 2-fluorocyclopropyl.
E very especially preferably represents the radical 6-chloropyrid-3-yl, 6-bromopyrid-3-yl or 6-chloro-1,4-pyridazin-3-yl.
B very especially preferably represents oxygen.
R² very especially preferably represents hydrogen.
R³ very especially preferably represents hydrogen.
R⁴ very especially preferably represents 2,2-difluoroethyl.

In an emphasized group of compounds of the formula (I-a), E represents 6-chloropyrid-3-yl

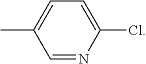

In a further emphasized group of compounds of the formula (I-a), E represents 6-bromopyrid-3-yl

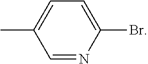

In a further emphasized group of compounds of the formula (I-a), E represents 6-chloro-1,4-pyridazin-3-yl

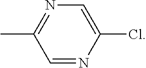

In a further emphasized group of compounds of the formula (I-a), E represents 2-chloro-1,3-thiazol-5-yl

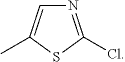

The following text defines a further group of preferred compounds of the formula (I-a) in which
E represents pyrid-3-yl which is substituted in the 6-position by fluorine, chlorine, bromine, methyl or trifluoromethyl, or represents 2-chloropyrazin-5-yl or 2-chloro-1,3-thiazol-5-yl,
B represents oxygen, sulphur or methylene,
R² represents hydrogen or halogen,
R³ represents hydrogen or methyl,
R⁴ represents halo-C₁₋₃-alkyl, halo-C₂₋₃-alkenyl, halocyclopropyl (where halo represents, in particular, fluorine or chlorine),
E preferably represents 6-fluoropyrid-3-yl, 6-chloropyrid-3-yl, 6-bromopyrid-3-yl, 6-trifluoromethylpyrid-3-yl, 2-chloropyrazin-5-yl or 2-chloro-1,3-thiazol-5-yl,
B preferably represents oxygen or methylene,
R² preferably represents hydrogen or halogen (where halogen represents, in particular, fluorine or chlorine),
R³ preferably represents in each case hydrogen,
R⁴ preferably represents difluoromethyl, 2-fluoroethyl, 2,2-difluoroethyl, 2-chloro-2-fluoroethyl, 3-fluoro-n-propyl, 2-fluorovinyl, 3,3-difluoroprop-2-enyl or 3,3-dichloroprop-2-enyl,
E especially preferably represents the radical 6-chloropyrid-3-yl or 6-bromopyrid-3-yl,
B especially preferably represents oxygen,
R² especially preferably represents hydrogen,
R³ especially preferably represents hydrogen,
R⁴ especially preferably represents 2-fluoroethyl or 2,2-difluoroethyl,
E very especially preferably represents the radical 6-chloropyrid-3-yl or 6-bromopyrid-3-yl,
B very especially preferably represents oxygen,
R² very especially preferably represents hydrogen,
R³ very especially preferably represents hydrogen and
R⁴ very especially preferably represents 2,2-difluoroethyl.

In an emphasized group of compounds of the formula (I-a), R³ represents hydrogen, B represents oxygen and E represents 6-chloropyrid-3-yl

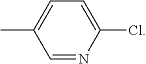

In a further emphasized group of compounds of the formula (I-a), R³ represents hydrogen, B represents oxygen and E represents 6-bromopyrid-3-yl

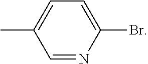

In a further emphasized group of compounds of the formula (I-a), R³ represents hydrogen, B represents oxygen and E represents 6-fluoropyrid-3-yl

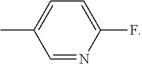

In a further emphasized group of compounds of the formula (I-a), R³ represents hydrogen, B represents oxygen and E represents 6-trifluoromethylpyrid-3-yl

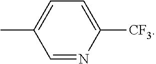

In a further emphasized group of compounds of the formula (I-a), R³ represents hydrogen, B represents oxygen and E represents 2-chloro-1,3-thiazol-5-yl

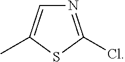

In a further emphasized group of compounds of the formula (I-a), R² and R³ represent hydrogen. B represents oxygen and E represents 6-chloropyrid-3-yl

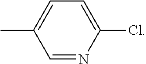

In a further emphasized group of compounds of the formula (I-a), R² and R³ represent hydrogen, B represents oxygen and E represents 6-bromopyrid-3-yl

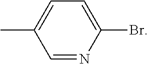

In a further emphasized group of compounds of the formula (I-a), R² and R³ represent hydrogen, B represents oxygen and E represents 6-fluoropyrid-3-yl

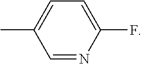

In a further emphasized group of compounds of the formula (I-a), R² and R³ represent hydrogen, B represents oxygen and E represents 6-trifluoromethylpyrid-3-yl

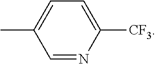

In a further emphasized group of compounds of the formula (I-a), R² and R³ represent hydrogen, B represents oxygen and E represents 2-chloro-1,3-thiazol-5-yl

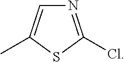

In a further emphasized group of compounds of the formula (I-a), R² and R³ represent hydrogen, B represents methylene and E represents 6-chloropyrid-3-yl

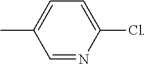

In a further emphasized group of compounds of the formula (I-a), R² and R³ represent hydrogen, B represents methylene and E represents 6-bromopyrid-3-yl

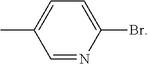

In a further emphasized group of compounds of the formula (I-a), R² and R³ represent hydrogen, B represents methylene and E represents 6-fluoropyrid-3-yl

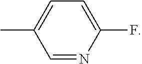

In a further emphasized group of compounds of the formula (I-a), R² and R³ represent hydrogen, B represents methylene and E represents 6-trifluoromethylpyrid-3-yl

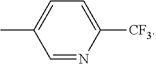

In a further emphasized group of compounds of the formula (I-a), R² and R³ represent hydrogen, B represents methylene and E represents 2-chloro-1,3-thiazol-5-yl

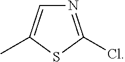

In a further emphasized group of compounds of the formula (I-a), R⁴ represents difluoromethyl, R² and R³ represent hydrogen and B represents oxygen.

In a further emphasized group of compounds of the formula (I-a), R⁴ represents 2-fluoroethyl, R² and R³ represent hydrogen and B represents oxygen.

In a further emphasized group of compounds of the formula (I-a), R⁴ represents 2,2-difluoroethyl, R² and R³ represent hydrogen and B represents oxygen.

In a further emphasized group of compounds of the formula (I-a), R⁴ represents difluoromethyl, R² and R³ represent hydrogen and B represents methylene.

In a further emphasized group of compounds of the formula (I-a), R⁴ represents 2-fluoroethyl, R² and R³ represent hydrogen and B represents methylene.

In a further emphasized group of compounds of the formula (I-a), R⁴ represents 2,2-difluoroethyl, R² and R³ represent hydrogen and B represents methylene.

A further preferred subgroup of the enaminocarbonyl compounds to be used according to the invention are those of the formula (I-b)

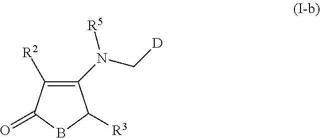

in which
D represents a radical pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl, which radical is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine) or C₁-C₃-alkylsulphonyl (which is optionally substituted by fluorine and/or chlorine),
or
D represents a radical

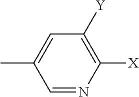

in which
X and Y have the abovementioned meanings,
R⁵ represents hydrogen, alkyl, alkenyl, alkynyl, cycloalkyl or alkoxy,
and R², R³ and B have the abovementioned meanings.

Preferred substituents or ranges of the radicals in the formula (I-b) mentioned hereinabove and hereinbelow are explained in the following text.
D preferably represents 2-chloropyrimidin-5-yl or 2-trifluoromethylpyrimidin-5-yl, furthermore
D preferably represents one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl.
B preferably represents oxygen or methylene.
R² preferably represents hydrogen or halogen (where halogen represents, in particular, fluorine or chlorine).
R³ preferably represents hydrogen.
R⁵ preferably represents C₁-C₄-alkyl, C₂-C₄-alkenyl, C₂-C₄-alkynyl or C₃-C₄-cycloalkyl.
D especially preferably represents 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl.
B especially preferably represents oxygen.
R² especially preferably represents hydrogen.
R³ especially preferably represents hydrogen.
D very especially preferably represents 5-fluoro-6-chloropyrid-3-yl or 5-fluoro-6-bromopyrid-3-yl.
B very especially preferably represents oxygen.
R² very especially preferably represents hydrogen.
R³ very especially preferably represents hydrogen.
R⁵ very especially preferably represents methyl, ethyl, propyl, vinyl, allyl, propargyl or cyclopropyl.

In an emphasized group of compounds of the formula (I-b), R³ represents hydrogen, B represents oxygen and D represents 2-chloropyrimidin-5-yl,

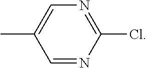

In a further emphasized group of compounds of the formula (I-b), R³ represents hydrogen, B represents oxygen and D represents 5-fluoro-6-chloropyrid-3-yl.

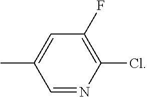

In a further emphasized group of compounds of the formula (I-b), R³ represents hydrogen, B represents oxygen and D represents 5,6-dichloropyrid-3-yl

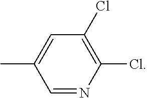

In a further emphasized group of compounds of the formula (I-b), R³ represents hydrogen, B represents oxygen and D represents 5-bromo-6-chloropyrid-3-yl

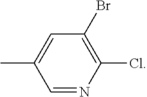

In a further emphasized group of compounds of the formula (I-b), R³ represents hydrogen, B represents oxygen and D represents 5-methyl-6-chloropyrid-3-yl

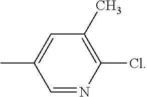

In a further emphasized group of compounds of the formula (I-b), R³ represents hydrogen, B represents oxygen and D represents 5-fluoro-6-bromopyrid-3-yl

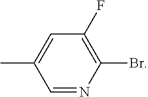

In a further emphasized group of compounds of the formula (I-b), R³ represents hydrogen, B represents oxygen and D represents 5-chloro-6-bromopyrid-3-yl

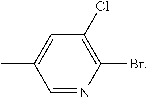

In a further emphasized group of compounds of the formula (I-b), R³ represents hydrogen, B represents oxygen and D represents 5-chloro-6-iodopyrid-3-yl

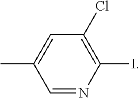

In a further emphasized group of compounds of the formula (I-b), R² and R³ represent hydrogen, B represents oxygen and D represents 2-chloropyrimidin-5-yl,

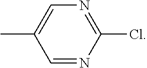

In a further emphasized group of compounds of the formula (I-b), R² and R³ represent hydrogen, B represents oxygen and D represents 5-fluoro-6-chloropyrid-3-yl,

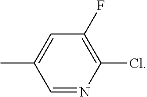

In a further emphasized group of compounds of the formula (I-b), R² and R³ represent hydrogen, B represents oxygen and D represents 5,6-dichloropyrid-3-yl

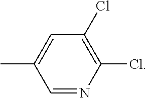

In a further emphasized group of compounds of the formula (I-b), R² and R³ represent hydrogen, B represents oxygen and D represents 5-bromo-6-chloropyrid-3-yl

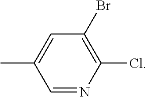

In a further emphasized group of compounds of the formula (I-b), R² and R³ represent hydrogen, B represents oxygen and D represents 5-methyl-6-chloropyrid-3-yl

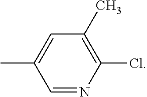

In a further emphasized group of compounds of the formula (I-b), R² and R³ represent hydrogen, B represents oxygen and D represents 5-fluoro-6-bromopyrid-3-yl

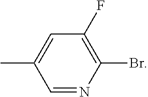

In a further emphasized group of compounds of the formula (I-b), R² and R³ represent hydrogen, B represents oxygen and D represents 5-chloro-6-bromopyrid-3-yl

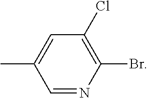

In a further emphasized group of compounds of the formula (I-b), R² and R³ represent hydrogen, B represents oxygen and D represents 5-chloro-6-iodopyrid-3-yl

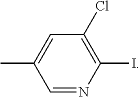

In a further emphasized group of compounds of the formula (I-b), R² and R³ represent hydrogen, B represents methylene and D represents 2-chloropyrimidin-5-yl,

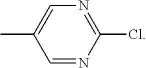

In a further emphasized group of compounds of the formula (I-b), R² and R³ represent hydrogen, B represents methylene and D represents 5-fluoro-6-chloropyrid-3-yl,

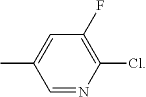

In a further emphasized group of compounds of the formula (I-b), R² and R³ represent hydrogen, B represents methylene and D represents 5,6-dichloropyrid-3-yl

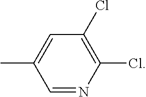

In a further emphasized group of compounds of the formula (I-b), R² and R³ represent hydrogen, B represents methylene and D represents 5-bromo-6-chloropyrid-3-yl

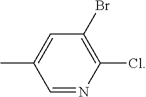

In a further emphasized group of compounds of the formula (I-b), R² and R³ represent hydrogen, B represents methylene and D represents 5-methyl-6-chloropyrid-3-yl

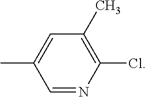

In a further emphasized group of compounds of the formula (I-b), R² and R³ represent hydrogen, B represents methylene and D represents 5-fluoro-6-bromopyrid-3-yl

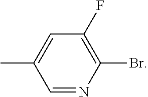

In a further emphasized group of compounds of the formula (I-b), R² and R³ represent hydrogen, B represents methylene and D represents 5-chloro-6-bromopyrid-3-yl

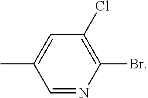

In a further emphasized group of compounds of the formula (I-b), R² and R³ represent hydrogen, B represents methylene and D represents 5-chloro-6-iodopyrid-3-yl

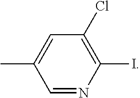

In a further emphasized group of compounds of the formula (I-b), R⁵ represents methyl, R² and R³ represent hydrogen and B represents oxygen.

In a further emphasized group of compounds of the formula (I-b), R⁵ represents ethyl, R² and R³ represent hydrogen and B represents oxygen.

In a further emphasized group of compounds of the formula (I-b), R⁵ represents cyclopropyl, R² and R³ represent hydrogen and B represents oxygen.

In a further emphasized group of compounds of the formula (I-b), R⁵ represents methyl, R² and R³ represent hydrogen and B represents methylene.

In a further emphasized group of compounds of the formula (I-b), R⁵ represents ethyl, R² and R³ represent hydrogen and B represents methylene.

In a further emphasized group of compounds of the formula (I-b), R⁵ represents cyclopropyl, R² and R³ represent hydrogen and B represents methylene.

A further preferred subgroup of the enaminocarbonyl compounds according to the invention are those of the formula (I-c)

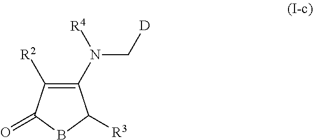

in which
D represents a radical pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl, which radical is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine) or C₁-C₃-alkylsulphonyl (which is optionally substituted by fluorine and/or chlorine),
or
D represents a radical

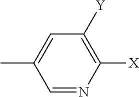

in which
X and Y have the abovementioned meanings.
R⁴ represents haloalkyl, haloalkenyl, halocycloalkyl or halocycloalkylalkyl, and R², R³ and B have the abovementioned meanings.

Preferred substituents or ranges of the radicals detailed in the formula (I-c) mentioned hereinabove and hereinbelow are explained in the following text.
D preferably represents 2-chloropyrimidin-5-yl or 2-trifluoromethylpyrimidin-5-yl,
furthermore
D preferably represents one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl.
B preferably represents oxygen or methylene.
R² preferably represents oxygen or halogen (where halogen represents, in particular, fluorine or chlorine).
R³ preferably represents hydrogen.
R⁴ preferably represents fluorine-substituted C₁-C₅-alkyl, C₂-C₅-alkenyl, C₃-C₅-cycloalkyl or C₃-C₅-cycloalkylalkyl.
D especially preferably represents 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl.
B especially preferably represents oxygen.
R² especially preferably represents hydrogen.
R³ especially preferably represents hydrogen.
R⁴ especially preferably represents 2-fluoroethyl, 2,2-difluoroethyl, 2-fluorocyclopropyl.
D very especially preferably represents 5-fluoro-6-chloropyrid-3-yl or 5-fluoro-6-bromopyrid-3-yl.
B very especially preferably represents oxygen.
R² very especially preferably represents hydrogen.
R³ very especially preferably represents hydrogen.
R⁴ very especially preferably represents 2,2-difluoroethyl.

In an emphasized group of compounds of the formula (I-c), R³ represents hydrogen, B represents oxygen and D represents 2-chloropyrimidin-5-yl,

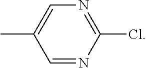

In a further emphasized group of compounds of the formula (I-c), R³ represents hydrogen, B represents oxygen and D represents 5-fluoro-6-chloropyrid-3-yl,

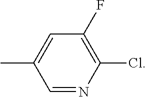

In a further emphasized group of compounds of the formula (I-c), R³ represents hydrogen, B represents oxygen and D represents 5,6-dichloropyrid-3-yl

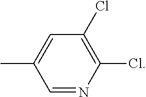

In a further emphasized group of compounds of the formula (I-c), R³ represents hydrogen. B represents oxygen and D represents 5-bromo-6-chloropyrid-3-yl

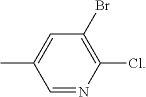

In a further emphasized group of compounds of the formula (I-c), R³ represents hydrogen, B represents oxygen and D represents 5-methyl-6-chloropyrid-3-yl

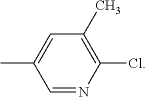

In a further emphasized group of compounds of the formula (I-c), R³ represents hydrogen, B represents oxygen and D represents 5-fluoro-6-bromopyrid-3-yl

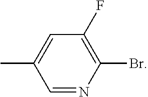

In a further emphasized group of compounds of the formula (I-c), R³ represents hydrogen, B represents oxygen and D represents 5-chloro-6-bromopyrid-3-yl

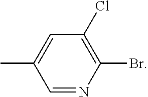

In a further emphasized group of compounds of the formula (I-c), R³ represents hydrogen, B represents oxygen and D represents 5-chloro-6-iodopyrid-3-yl

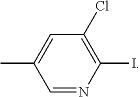

In an emphasized group of compounds of the formula (I-c), R² and R³ represent hydrogen, B represents oxygen and D represents 2-chloropyrimidin-5-yl,

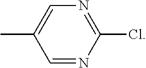

In a further emphasized group of compounds of the formula (I-c), R² and R³ represent hydrogen, B represents oxygen and D represents 5-fluoro-6-chloropyrid-3-yl,

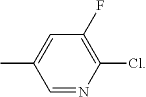

In a further emphasized group of compounds of the formula (I-c), R² and R³ represent hydrogen, B represents oxygen and D represents 5,6-dichloropyrid-3-yl

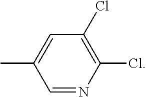

In a further emphasized group of compounds of the formula (I-c), R² and R³ represent hydrogen, B represents oxygen and D represents 5-bromo-6-chloropyrid-3-yl

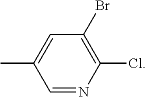

In a further emphasized group of compounds of the formula (I-c), R² and R³ represent hydrogen, B represents oxygen and D represents 5-methyl-6-chloropyrid-3-yl

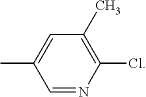

In a further emphasized group of compounds of the formula (I-c), R² and R³ represent hydrogen, B represents oxygen and D represents 5-fluoro-6-bromopyrid-3-yl

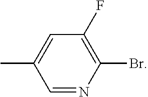

In a further emphasized group of compounds of the formula (I-c), R² and R³ represent hydrogen, B represents oxygen and D represents 5-chloro-6-bromopyrid-3-yl

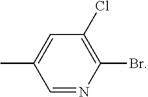

In a further emphasized group of compounds of the formula (I-c), R² and R³ represent hydrogen, B represents oxygen and D represents 5-chloro-6-iodopyrid-3-yl

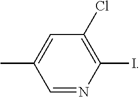

In an emphasized group of compounds of the formula (I-c), R² and R³ represent hydrogen, B represents methylene and D represents 2-chloropyrimidin-5-yl,

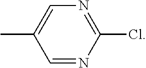

In a further emphasized group of compounds of the formula (I-c), R² and R³ represent hydrogen, B represents methylene and D represents 5-fluoro-6-chloropyrid-3-yl,

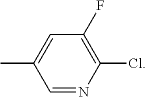

In a further emphasized group of compounds of the formula (I-c), R² and R³ represent hydrogen, B represents methylene and D represents 5,6-dichloropyrid-3-yl

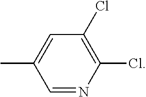

In a further emphasized group of compounds of the formula (I-c), R² and R³ represent hydrogen, B represents methylene and D represents 5-bromo-6-chloropyrid-3-yl

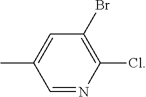

In a further emphasized group of compounds of the formula (I-c), R² and R³ represent hydrogen, B represents methylene and D represents 5-methyl-6-chloropyrid-3-yl

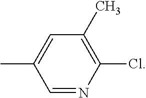

In a further emphasized group of compounds of the formula (I-c), R² and R³ represent hydrogen, B represents methylene and D represents 5-fluoro-6-bromopyrid-3-yl

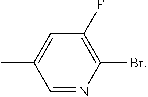

In a further emphasized group of compounds of the formula (I-c), R² and R³ represent hydrogen, B represents methylene and D represents 5-chloro-6-bromopyrid-3-yl

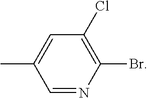

In a further emphasized group of compounds of the formula (I-c), R² and R³ represent hydrogen, B represents methylene and D represents 5-chloro-6-iodopyrid-3-yl

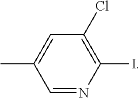

In a further emphasized group of compounds of the formula (I-c), R⁴ represents difluoromethyl, R² and R³ represent hydrogen and B represents oxygen.

In a further emphasized group of compounds of the formula (I-c), R⁴ represents 2-fluoroethyl, R² and R³ represent hydrogen and B represents oxygen.

In a further emphasized group of compounds of the formula (I-c), R⁴ represents 2,2-difluoroethyl, R² and R³ represent hydrogen and B represents oxygen.

In a further emphasized group of compounds of the formula (I-c), R⁴ represents difluoromethyl, R² and R³ represent hydrogen and B represents methylene.

In a further emphasized group of compounds of the formula (I-c), R⁴ represents 2-fluoroethyl, R² and R³ represent hydrogen and B represents methylene.

In a further emphasized group of compounds of the formula (I-c), R⁴ represents 2,2-difluoroethyl, R² and R³ represent hydrogen and B represents methylene.

A preferred subgroup of the enaminocarbonyl compounds according to the invention are those of the formula (I-d)

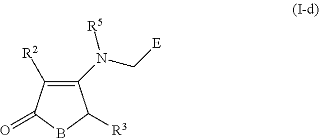

in which
E represents pyrid-2-yl or pyrid-4-yl, or represents pyrid-3-yl which is optionally substituted in the 6-position by fluorine, chlorine, bromine, methyl, trifluoromethyl or trifluoromethoxy, or represents pyridazin-3-yl which is optionally substituted in the 6-position by chlorine or methyl, or represents pyrazin-3-yl or represents 2-chloropyrazin-5-yl, or represents 1,3-thiazol-5-yl which is optionally substituted in the 2-position by chlorine or methyl.
R⁵ represents C₁-C₄-alkyl, C₂-C₄-alkenyl, C₂-C₄-alkynyl, C₃-C₄-cycloalkyl or C₁-C₄-alkoxy,
and R², R³ and B have the abovementioned meanings.

Preferred substituents or ranges of the radicals detailed in formula (I-d) mentioned hereinabove and hereinbelow are explained in the following text.
E preferably represents 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
B preferably represents oxygen or methylene,
R² preferably represents hydrogen or halogen (where halogen represents, in particular, fluorine or chlorine),
R³ preferably represents in each case hydrogen or methyl,
R⁵ preferably represents C₁-C₄-alkyl, C₂-C₄-alkenyl, C₂-C₄-alkynyl or C₃-C₄-cycloalkyl.
E especially preferably represents the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl,
B especially preferably represents oxygen or methylene,
R² especially preferably represents hydrogen,
R³ especially preferably represents hydrogen,
R⁵ especially preferably represents methyl, ethyl, propyl, vinyl, allyl, propargyl or cyclopropyl.
E very especially preferably represents the radical 6-chloropyrid-3-yl, 6-bromopyrid-3-yl or 6-chloro-1,4-pyridazin-3-yl,
B very especially preferably represents oxygen,
R² very especially preferably represents hydrogen,
R³ very especially preferably represents hydrogen.
R⁵ very especially preferably represents methyl, ethyl or cyclopropyl.

In an emphasized group of compounds of the formula (I-d), E represents 6-chloropyrid-3-yl

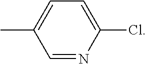

In a further emphasized group of compounds of the formula (I-d), E represents 6-bromopyrid-3-yl

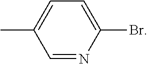

In a further emphasized group of compounds of the formula (I-d), E represents 6-chloro-1,4-pyridazin-3-yl

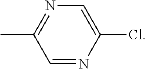

In a further emphasized group of compounds of the formula (I-d), E represents 2-chloro-1,3-thiazol-5-yl

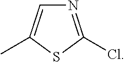

The following text defines a further group of preferred compounds of the formula (I-d) in which
E represents pyrid-3-yl which is substituted in the 6-position by fluorine, chlorine, bromine, methyl or trifluoromethyl, or represents 2-chloropyrazin-5-yl or 2-chloro-1,3-thiazol-5-yl,
B represents oxygen, sulphur or methylene,
R² represents hydrogen or halogen,
R³ represents hydrogen or methyl,
R⁵ represents C₁-C₄-alkyl, alkenyl, alkynyl, cycloalkyl or alkoxy,
E preferably represents 6-fluoropyrid-3-yl, 6-chloropyrid-3-yl, 6-bromopyrid-3-yl, 6-trifluoromethylpyrid-3-yl, 2-chloropyrazin-5-yl or 2-chloro-1,3-thiazol-5-yl,
B preferably represents oxygen or methylene,
R² preferably represents hydrogen or halogen (where halogen represents, in particular, fluorine or chlorine).
R³ preferably represents in each case hydrogen,
R⁵ preferably represents C₁-C₄-alkyl, C₂-C₄-alkenyl, C₂-C₄-alkynyl or C₃-C₄-cycloalkyl,
E especially preferably represents the radical 6-chloropyrid-3-yl or 6-bromopyrid-3-yl,
B especially preferably represents oxygen,
R² especially preferably represents hydrogen,
R³ especially preferably represents hydrogen.
R⁵ especially preferably represents methyl, ethyl, propyl, vinyl, allyl, propargyl or cyclopropyl,
E very especially preferably represents the radical 6-chloropyrid-3-yl or 6-bromopyrid-3-yl.
B very especially preferably represents oxygen,
R² very especially preferably represents hydrogen.
R³ very especially preferably represents hydrogen and
R⁵ very especially preferably represents ethyl or cyclopropyl.

In an emphasized group of compounds of the formula (I-d), R³ represents hydrogen, B represents oxygen and E represents 6-chloropyrid-3-yl

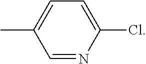

In a further emphasized group of compounds of the formula (I-d), R³ represents hydrogen, B represents oxygen and E represents 6-bromopyrid-3-yl

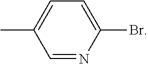

In a further emphasized group of compounds of the formula (I-d), R³ represents hydrogen, B represents oxygen and E represents 6-fluoropyrid-3-yl

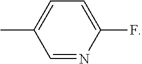

In a further emphasized group of compounds of the formula (I-d), R³ represents hydrogen, B represents oxygen and E represents 6-trifluoromethylpyrid-3-yl

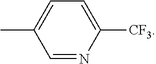

In a further emphasized group of compounds of the formula (I-d), R³ represents hydrogen, B represents oxygen and E represents 2-chloro-1,3-thiazol-5-yl

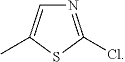

In a further emphasized group of compounds of the formula (I-d), R² and R³ represent hydrogen, B represents oxygen and E represents 6-chloropyrid-3-yl

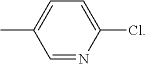

In a further emphasized group of compounds of the formula (I-d), R² and R³ represent hydrogen, B represents oxygen and E represents 6-bromopyrid-3-yl

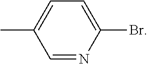

In a further emphasized group of compounds of the formula (I-d), R² and R³ represent hydrogen, B represents oxygen and E represents 6-fluoropyrid-3-yl

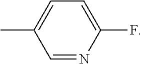

In a further emphasized group of compounds of the formula (I-d), R² and R³ represent hydrogen, B represents oxygen and E represents 6-trifluoromethylpyrid-3-yl

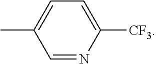

In a further emphasized group of compounds of the formula (I-d), R² and R³ represent hydrogen, B represents oxygen and E represents 2-chloro-1,3-thiazol-5-yl

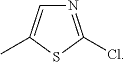

In a further emphasized group of compounds of the formula (I-d), R² and R³ represent hydrogen, B represents methylene and E represents 6-chloropyrid-3-yl

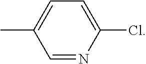

In a further emphasized group of compounds of the formula (I-d), R² and R³ represent hydrogen, B represents methylene and E represents 6-bromopyrid-3-yl

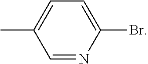

In a further emphasized group of compounds of the formula (I-d), R² and R³ represent hydrogen, B represents methylene and E represents 6-fluoropyrid-3-yl

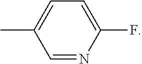

In a further emphasized group of compounds of the formula (I-d), R² and R³ represent hydrogen, B represents methylene and E represents 6-trifluoromethylpyrid-3-yl

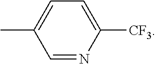

In a further emphasized group of compounds of the formula (I-d), R² and R³ represent hydrogen, B represents methylene and E represents 2-chloro-1,3-thiazol-5-yl

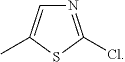

In a further emphasized group of compounds of the formula (I-d), R⁵ represents methyl, R² and R³ represent hydrogen and B represents oxygen.

In a further emphasized group of compounds of the formula (I-d), R⁵ represents ethyl, R² and R³ represent hydrogen and B represents oxygen.

In a further emphasized group of compounds of the formula (I-d), R⁵ represents cyclopropyl, R² and R³ represent hydrogen and B represents oxygen.

In a further emphasized group of compounds of the formula (I-d), R⁵ represents methyl, R² and R³ represent hydrogen and B represents methylene.

In a further emphasized group of compounds of the formula (I-d), R⁵ represents ethyl, R² and R³ represent hydrogen and B represents methylene.

In a further emphasized group of compounds of the formula (I-d), R⁵ represents cyclopropyl, R² and R³ represent hydrogen and B represents methylene.

The following compounds of the general formula (I) may be mentioned individually:
compound (I-1), 4-{[(6-bromopyrid-3-yl)methyl](2-fluoroethyl)amino}furan-2(5H)-one, has the formula

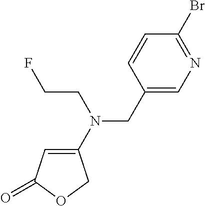 [SMILES: O=C1C=C(N(CCF)Cc2ccc(Br)nc2)CO1]

and is known from the International patent application WO 2007/115644.
compound (I-2), 4-{[(6-bromopyrid-3-yl)methyl](2,2-difluoroethyl)amino}furan-2(5H)-one, has the formula

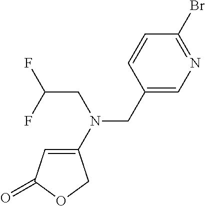 [SMILES: O=C1C=C(N(Cc2ccc(Br)nc2)CC(F)F)CO1]

and is known from the International patent application WO 2007/115644.
compound (I-3), 4-{[(6-fluoropyrid-3-yl)methyl](2,2-difluoroethyl)amino}furan-2(5H)-one, has the formula

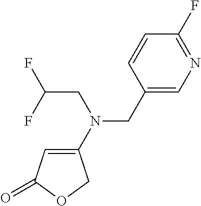 [SMILES: O=C1C=C(N(Cc2ccc(F)nc2)CC(F)F)CO1]

and is known from the International patent application WO 2007/115644.
compound (I-4), 4-{[(2-chloro-1,3-thiazol-5-yl)methyl](2-fluoroethyl)amino}furan-2(5H)-one, has the formula

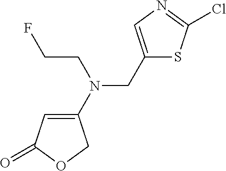 [SMILES: O=C1C=C(N(CCF)Cc2cnc(Cl)s2)CO1]

and is known from the International patent application WO 2007/115644.
compound (I-5), 3-chloro-4-[(6-chloropyrid-3-yl)methyl](2-fluoroethyl)amino) furan-2(5H)-one, has the formula

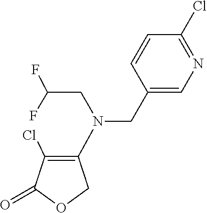 [SMILES: O=C1OCC(N(Cc2ccc(Cl)nc2)CC(F)F)=C1Cl]

and is known from the International patent application WO 2007/115644.
compound (I-6), 4-{[(6-chloropyrid-3-yl)methyl](2-fluoroethyl)amino}furan-2(5H)-one, has the formula

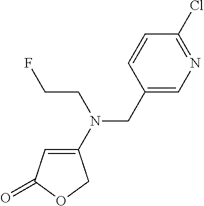 [SMILES: O=C1C=C(N(CCF)Cc2ccc(Cl)nc2)CO1]

and is known from the International patent application WO 2007/115644.
compound (I-7), 4-{[(6-chloropyrid-3-yl)methyl](2,2-difluoroethyl)amino}furan-2(5H)-one, has the formula

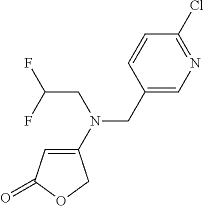 [SMILES: O=C1C=C(N(Cc2ccc(Cl)nc2)CC(F)F)CO1]

and is known from the International patent application WO 2007/115644.
compound (I-8), 4-{[(6-chloro-5-fluoropyrid-3-yl)methyl](methyl)amino}furan-2(5H)-one, has the formula

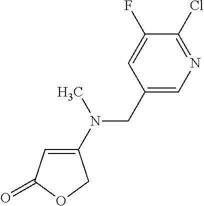 [SMILES: CN(Cc1cnc(Cl)c(F)c1)C1=CC(=O)OC1]

and is known from the International patent application WO 2007/115643.
compound (I-9), 4-{[(5,6-dichloropyrid-3-yl)methyl](cyclopropyl)amino}furan-2(5H)-one, has the formula

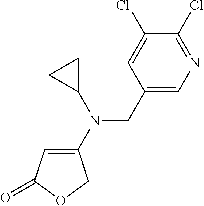 [SMILES: O=C1C=C(N(Cc2cnc(Cl)c(Cl)c2)C2CC2)CO1]

and is known from the International patent application WO 2007/115643.
compound (I-10), 4-{[(5,6-dichloropyrid-3-yl)methyl](methyl)amino}furan-2(5H)-one, has the formula

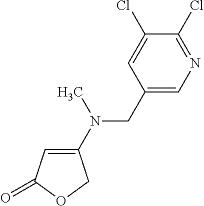 [SMILES: CN(Cc1cnc(Cl)c(Cl)c1)C1=CC(=O)OC1]

and is known from the International patent application WO 2007/115643.
compound (I-11), 4-{[(6-bromo-5-fluoropyrid-3-yl)methyl](methyl)amino}furan-2(5H)-one, has the formula

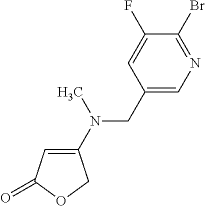 [SMILES: CN(Cc1cnc(Br)c(F)c1)C1=CC(=O)OC1]

and is known from the International patent application WO 2007/115643.
compound (I-12), 4-{[(6-bromo-5-fluoropyrid-3-yl)methyl](cyclopropyl)amino}furan-2(5H)-one, has the formula

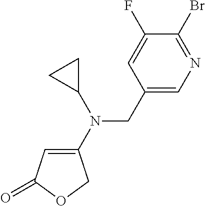 [SMILES: O=C1C=C(N(Cc2cnc(Br)c(F)c2)C2CC2)CO1]

and is known from the International patent application WO 2007/115643.
compound (I-13), 4-{[(6-chloro-5-fluoropyrid-3-yl)melhyl](cyclopropyl)amino}furan-2(5H)-one, has the formula

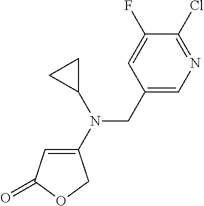 [SMILES: O=C1C=C(N(Cc2cnc(Cl)c(F)c2)C2CC2)CO1]

and is known from the International patent application WO 2007/115643.
compound (I-14), 4-{[(5,6-dichloropyrid-3-yl)methyl](2-fluoroethyl)amino}furan-2(5H)-one, has the formula

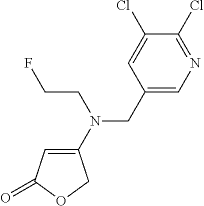 [SMILES: O=C1C=C(N(CCF)Cc2cnc(Cl)c(Cl)c2)CO1]

and is known from the International patent application WO 2007/115646.
compound (I-15), 4-{[(5,6-dichloropyrid-3-yl)methyl](2-fluoroethyl)amino}furan-2(5H)-one, has the formula

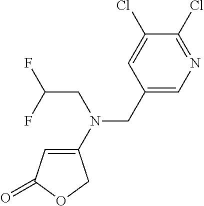 [SMILES: O=C1C=C(N(Cc2cnc(Cl)c(Cl)c2)CC(F)F)CO1]

and is known from the International patent application WO 2007/115646.
compound (I-16), 4-{[(6-bromo-5-fluoropyrid-3-yl)methyl](2,2-difluoroethyl)amino}furan-2(5H)-one, has the formula

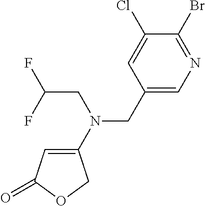 [SMILES: O=C1C=C(N(Cc2cnc(Br)c(Cl)c2)CC(F)F)CO1]

and is known from the International patent application WO 2007/115646.
compound (I-17), 4-{[(6-chloro-5-fluoropyrid-3-yl)methyl](2,2-difluoroethyl)amino}furan-2(5H)-one, has the formula

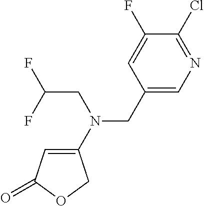 [SMILES: O=C1C=C(N(Cc2cnc(Cl)c(F)c2)CC(F)F)CO1]

and is known from the International patent application WO 2007/115646.
compound (I-18), 3-{[(6-chloropyrid-3-yl)methyl](methyl)amino}cyclopent-2-en-1-one, has the formula

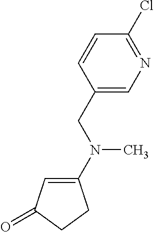 [SMILES: CN(Cc1ccc(Cl)nc1)C1=CC(=O)CC1]

and is known from WO 92/00964.
compound (I-19), 3-{[(6-chloropyrid-3-yl)methyl](cyclopropyl)amino}cyclopent-2-en-1-one, has the formula

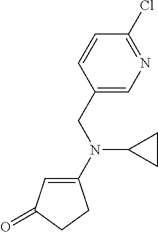 [SMILES: O=C1C=C(N(Cc2ccc(Cl)nc2)C2CC2)CC1]

and is known from DE 10 2004 047 922 A.
compound (I-20), 4-{[(2-chloro-2,3-dihydro-1,3-thiazol-5-yl)methyl](methyl)amino}furan-2(5H)-one, has the formula

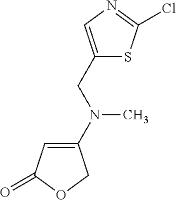

and is known from WO 92/00964 and DE 10 2004 047 922 A.
compound (I-21), 4-[methyl(pyrid-3-ylmethyl)amino]furan-2(5H)-one, has the formula

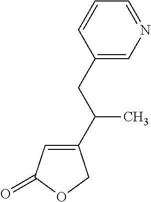

and is known from EP 0 539 588 A.
compound (I-22), 4-{cyclopropyl[(6-fluoropyrid-3-yl)methyl]amino}furan-2(5H)-one, has the formula

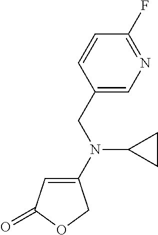 [SMILES: O=C1C=C(N(Cc2ccc(F)nc2)C2CC2)CO1]

and is known from EP 0 539 588 A.
compound (I-23), 4-(methyl{[6-(trifluoromethyl)pyrid-3-yl]methyl}amino)furan-2(5H)-one, has the formula

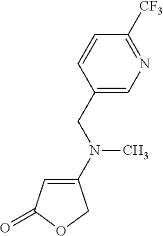 [SMILES: CN(Cc1ccc(C(F)(F)F)nc1)C1=CC(=O)OC1]

and is known from EP 0 539 588 A.
compound (I-24), 4-(cyclopropyl{[6-(trifluoromethyl)pyrid-3-yl]methyl}amino)furan-2(5H)-one, has the formula

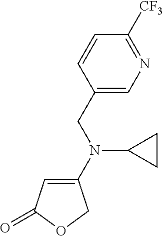 [SMILES: O=C1C=C(N(Cc2ccc(C(F)(F)F)nc2)C2CC2)CO1]

and is known from EP 0 539 588 A.
compound (I-25), 4-{[(6-chloropyrid-3-yl)methyl](methyl)amino}-5-methylfuran-2(5H)-one, has the formula

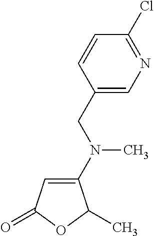 [SMILES: CC1OC(=O)C=C1N(C)Cc1ccc(Cl)nc1]

and is known from WO 92/00964 and DE 10 2004 047 922 A.
compound (I-26), 4-{[(6-bromopyrid-3-yl)methyl](methyl)amino}furan-2(5H)-one, has the formula

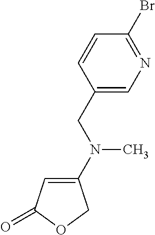 [SMILES: CN(Cc1ccc(Br)nc1)C1=CC(=O)OC1]

and is known from EP 0 539 588 A.
compound (I-27), 4-{[(6-chloropyrid-3-yl)methyl](methyl)amino}thiophen-2(5H)-one, has the formula

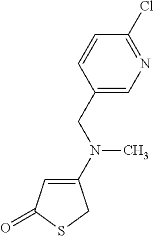 [SMILES: CN(Cc1ccc(Cl)nc1)C1=CC(=O)SC1]

and is known from EP 0 539 588 A.
compound (I-28), 4-{[(6-chloropyrid-3-yl)methyl](methyl)amino}-3-fluorofuran-2(5H)-one, has the formula

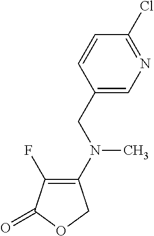 [SMILES: CN(Cc1ccc(Cl)nc1)C1=C(F)C(=O)OC1]

and is known from EP 0 539 588 A.
compound (I-29), 4-{[(6-chloropyrid-3-yl)methyl](methoxy)amino}furan-2(5)-one, has the formula

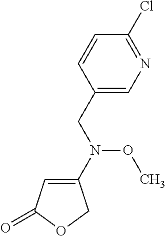 [SMILES: CON(Cc1ccc(Cl)nc1)C1=CC(=O)OC1]

and is known from EP 0 539 588 A.
compound (I-30), 4-{[(6-chloropyrid-3-yl)methyl](ethyl)amino}furan-2(5H)-one, has the formula

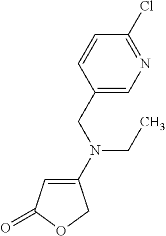 [SMILES: CCN(Cc1ccc(Cl)nc1)C1=CC(=O)OC1]

and is known from EP 0 539 588 A.
compound (I-31), 4-{[(6-chloropyrid-3-yl)methyl](cyclopropyl)amino}furan-2(5H)-one, has the formula

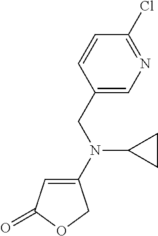 [SMILES: O=C1C=C(N(Cc2ccc(Cl)nc2)C2CC2)CO1]

and is known from EP 0 539 588 A.
compound (I-32), 4-{allyl[(6-chloropyrid-3-yl)methyl]amino}furan-2(5H)-one, has the formula

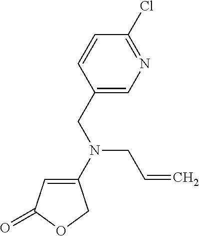 [SMILES: C=CCN(Cc1ccc(Cl)nc1)C1=CC(=O)OC1]

and is known from EP 0 539 588 A.
compound (I-33), 4-{[(6-chloropyrid-3-yl)methyl](prop-2-yn-1-yl)amino}furan-2(5H)-one, has the formula

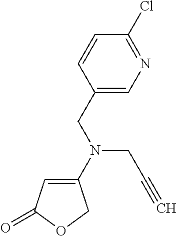 [SMILES: C#CCN(Cc1ccc(Cl)nc1)C1=CC(=O)OC1]

and is known from EP 0 539 588 A.
compound (I-34), 4-{[(6-chloropyrid-3-yl)methyl](methyl)amino}furan-2(5H)-one, has the formula

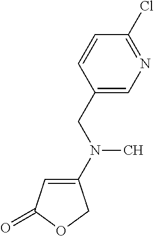 [SMILES: CN(Cc1ccc(Cl)nc1)C1=CC(=O)OC1]

and is known from EP 0 539 588 A.
compound (I-35), 4-{[(6-chloropyrid-3-yl)methyl]amino}furan-2(5H)-one, has the formula

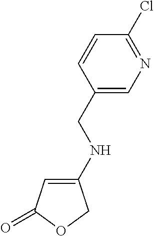 [SMILES: O=C1C=C(NCc2ccc(Cl)nc2)CO1]

and is known from EP 0 539 588 A.
compound (I-36), 4-{[(6-chloropyrid-3-yl)methyl](2,2-difluoromethyl)amino}furan-2(5H)-one, has the formula

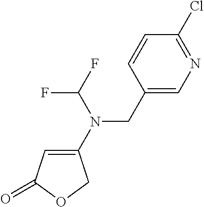 [SMILES: O=C1C=C(N(Cc2ccc(Cl)nc2)C(F)F)CO1]

and is known from the non-prior-published International patent application PCT/EP2007/002386.
compound (I-37), 4-{[(6-chloropyrid-3-yl)methyl](2-chloro-2-fluoroethyl)amino}furan-2(5H)-one, has the formula

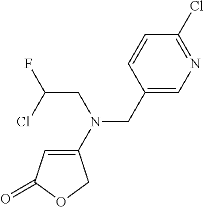 [SMILES: O=C1C=C(N(Cc2ccc(Cl)nc2)CC(F)Cl)CO1]

and is known from the non-prior-published International patent application PCT/EP2007/002386.
compound (I-38), 4-{[(6-chloropyrid-3-yl)methyl](2,2-difluoroethyl)amino}-3-bromofuran-2(5H)-one, has the formula

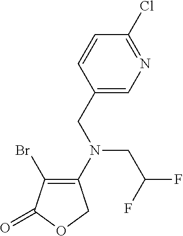 [SMILES: O=C1OCC(N(Cc2ccc(Cl)nc2)CC(F)F)=C1Br]

and is known from the International patent application WO 2007/115644.
compound (I-39), 4-([(6-chloro-5-methylpyrid-3-yl)methyl](cyclopropyl)amino furan-2(5H)-one, has the formula

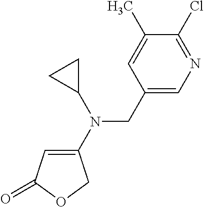 [SMILES: Cc1cc(CN(C2=CC(=O)OC2)C2CC2)cnc1Cl]

and is known from the International patent application WO 2007/115643.
compound (I-40), 4-{[(6-chloro-5-methylpyrid-3-yl)methyl](2,2-difluoroethyl)amino}furan-2(5H)-one, has the formula

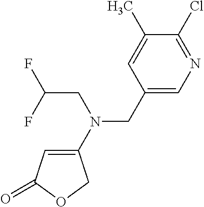 [SMILES: Cc1cc(CN(CC(F)F)C2=CC(=O)OC2)cnc1Cl]

and is known from the International patent application WO 2007/115646.
compound (I-41), 3-{[(6-chloropyrid-3-yl)methyl](propyl)amino}cyclohex-2-en-1-one, has the formula

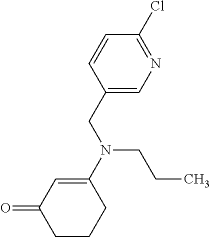 [SMILES: CCCN(Cc1ccc(Cl)nc1)C1=CC(=O)CCC1]

and is known from EP 0 539 588 A.
compound (I-42), 3-{allyl[(6-chloropyrid-3-yl)methyl]amino}cyclohex-2-en-1-one, has the formula

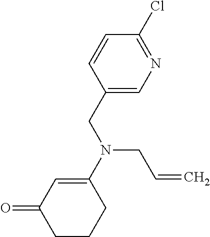 [SMILES: C=CCN(Cc1ccc(Cl)nc1)C1=CC(=O)CCC1]

and is known from EP 0 539 588 A.
compound (I-43), 3-{[(6-chloropyrid-3-yl)methyl](prop-2-yn-1-yl)amino}cyclohex-2-en-1-one, has the formula

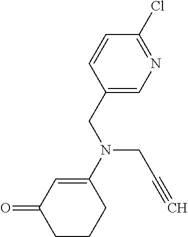 [SMILES: C#CCN(Cc1ccc(Cl)nc1)C1=CC(=O)CCC1]

and is known from EP 0 539 588 A.
compound (I-44), 3-{[(6-chloropyrid-3-yl)methyl]amino}cyclohex-2-en-1-one, has the formula

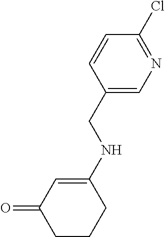 [SMILES: O=C1C=C(NCc2ccc(Cl)nc2)CCC1]

and is known from EP 0 539 588 A.
compound (I-45), 3-{[(6-chloropyrid-3-yl)methyl](methyl)amino}cyclohex-2-en-1-one, has the formula

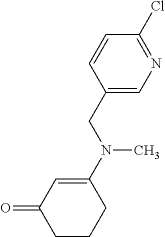 [SMILES: CN(Cc1ccc(Cl)nc1)C1=CC(=O)CCC1]

and is known from EP 0 539 588 A.
compound (I-46), 3-{[(6-chloropyrid-3-yl)methyl](ethyl)amino}cyclohex-2-en-1-one, has the formula

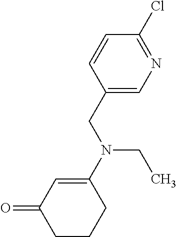 [SMILES: CCN(Cc1ccc(Cl)nc1)C1=CC(=O)CCC1]

and is known from EP 0 539 588 A.

Halogen-substituted radicals, for example haloalkyl, are monohalogenated or polyhalogenated up to the highest possible number of substituents. In the case of polyhalogenation, the halogen atoms may be identical or different. In this context, halogen represents fluorine, chlorine, bromine or iodine, in particular fluorine, chlorine or bromine.

Preferred, especially preferred or very especially preferred compounds are those which have attached to them the substituents mentioned as being preferred, especially preferred or very especially preferred in each case.

Saturated or unsaturated hydrocarbon radicals such as alkyl or alkenyl may, also in combination with hetero atoms, such as, for example, in alkoxy, be in each case straight-chain or branched, in as far as this is possible.

Optionally substituted radicals can be monosubstituted or polysubstituted, it being possible for the substituents to be identical or different in the case of polysubstitutions.

The abovementioned definitions of radicals or explanations which have been mentioned in general terms or in preferred ranges may, however, also be combined with one another as desired, that is to say that combinations between the respective ranges and preferred ranges are also possible.

When, within the scope of the present invention, the text mentions enaminocarbonyl compounds, these are generally enaminocarbonyl compounds of the general formula (I), it being possible in particular for the compounds of the general formulae (I-a) to (I-d), specifically for the compounds of the general formulae (I-1) to (I-46) to come to be embraced by the general formula (I).

In accordance with the invention, it has been demonstrated that the enaminocarbonyl compounds have an activity according to the invention on the growth of plants.

The term “growth of plants” is understood as meaning within the scope of the present invention various advantages for plants which are not directly connected to the known pesticidal activity, preferably the insecticidal activity, of the enaminocarbonyl compounds, in particular of the enaminocarbonyl compounds of the general formula (I). Such advantageous properties are, for example, the improved plant characteristics mentioned hereinbelow: accelerated germination and emergence of the generative and vegetative propagation material, improved root growth regarding surface area and depth, enhanced development of stolons or tillers, stronger and more productive stolons and tillers, improved shoot growth, increased standing power, increased shoot base diameters, increased leaf area, higher yields of nutrients and constituents such as, for example, carbohydrates, fats, oils, proteins, vitamins, minerals, essential oils, dyes, fibres, better fibre quality, earlier flowering, increased number of flowers, reduced content of toxic products such as mycotoxins, reduced content of residues or any type of disadvantageous components or better digestability, better storability of the harvested crop, improved tolerance to disadvantageous temperatures, improved tolerance to drought and dryness and also lack of oxygen as the result of water logging, improved tolerance to elevated soil salinity and water, increased tolerance to ozone stress, improved tolerance to herbicides and other plant treatment agents, improved water uptake and photosynthetic rate, advantageous plant properties such as, for example, accelerated maturation, more uniform maturation, greater attraction for beneficial animals, improved pollination, or other advantages which are well known to a person skilled in the art.

As is known, the various advantages for plants, which have been mentioned further above, can be combined in parts, and generally applicable terms can be used to describe them. Such terms are, for example, the following: phytotonic effect, resistance to stress factors, less plant stress, plant health, healthy plants, plant fitness, plant wellness, plant concept, vigor effect, stress shield, protective shield, crop health, crop health properties, crop health products, crop health management, crop health therapy, plant health, plant health properties, plant health products, plant health management, plant health therapy, greening effect or regreening effect, freshness, or other terms with which a person skilled in the art is quite familiar.

It has been demonstrated that the enaminocarbonyl compounds of the general formula (I) have a positive effect on the growth of plants. Within the scope of the present invention, the term “good effect within the scope of the present invention” is understood as meaning, but not by limitation.
at least an emergence which is improved by in general 5%, in particular 10%, especially preferably 15%, specifically 20%,
at least an increased yield which is in general 5%, in particular 10%, especially preferably 15%, specifically 20%,
at least an improved root development which is in general 5%, in particular 10%, especially preferably 15%, specifically 20%,
at least an increased shoot length which is in general 5%, in particular 10%, especially preferably 15%, specifically 20%,
at least an increased leaf area which is in general 5%, in particular 10%, especially preferably 15%, specifically 20%,
at least an improved germination which is in general 5%, in particular 10%, especially preferably 15%, specifically 20%,
at least an improved emergence which is in general 5%, in particular 10%, especially preferably 15%, specifically 20%, and/or
at least an improved photosynthetic rate which is in general 5%, in particular 10%, especially preferably 15%, specifically 20%,
   it being possible for the effects to manifest themselves individually or else in any combination of two or more effects.

In accordance with the invention, it has additionally been found that the application, to plants or to their environment, of enaminocarbonyl compounds in combination with a fertilizer as defined hereinbelow brings about a synergistic growth-promoting effect.

Fertilizers which can be employed in accordance with the invention together with the enaminocarbonyl compounds which have been explained in greater detail hereinabove are generally organic and inorganic nitrogen-containing compounds such as, for example, ureas, urea/formaldehyde condensates, amino acids, ammonium salts and ammonium nitrates, potassium salts (preferably chlorides, sulphates, nitrates), salts of phosphoric acid and/or salts of phosphorous acid (preferably potassium salts and ammonium salts). Those which must be mentioned in particular in this context are the NPK fertilizers, i.e. fertilizers which contain nitrogen, phosphorus and potassium, calcium ammonium nitrate, i.e. fertilizers which additionally contain calcium, or ammonia nitrate sulphate (general formula (NH₂)SO₄NH₄NO₃), ammonium phosphate and ammonium sulphate. These fertilizers are generally known to the skilled worker, see also, for example, Ullmann's Encyclopedia of Industrial Chemistry, 5th Edition, Vol. A 10, pages 323 to 431, Verlagsgesellschaft, Weinheim, 1987.

The fertilizers may also contain salts of micronutrients (preferably calcium, sulphur, boron, manganese, magnesium, iron, boron, copper, zinc, molybdenum and cobalt) and phytohormones (for example vitamin B1 and indole-3-acetic acid (IAA)) or mixtures of these. Fertilizers employed in accordance with the invention may also contain other salts such as monoammonium phosphate (MAP), diammonium phosphate (DAP), potassium sulphate, potassium chloride, magnesium sulphate. Suitable amounts of the secondary nutrients, or trace elements, are amounts of from 0.5 to 5% by weight, based on the totality of the fertilizer. Other possible constituents are plant protectants, insecticides or fungicides, growth regulators or mixtures of these. This will be explained in detail further below.

The fertilizers can be employed for example in the form of powders, granules, prills or compactates. However, the fertilizers can also be employed in liquid form, dissolved in an aqueous medium. In this case, dilute aqueous ammonia may also be employed as nitrogen fertilizer. Further possible constituents of fertilizers are described for example in Ullmann's Encyclopedia of Industrial Chemistry, 5th edition, 1987, Vol. A 10, pages 363 to 401, DE-A 41 28 828, DE-A 19 05 834 and DE-A 196 31 764.

The general composition of the fertilizers which, within the scope of the present invention, may take the form of straight and/or compound fertilizers, for example composed of nitrogen, potassium or phosphorus, may vary within a wide range. In general, a content of from 1 to 30% by weight of nitrogen (preferably 5 to 20% by weight), from 1 to 20% by weight of potassium (preferably from 3 to 15% by weight) and a content of from 1 to 20% by weight of phosphorus (preferably from 3 to 10% by weight) is advantageous. The microelement content is usually in the ppm order of magnitude, preferably in the order of magnitude of from 1 to 1000 ppm.

Within the scope of the present invention, the fertilizer and the enaminocarbonyl compound, in particular the enaminocarbonyl compound of the general formula (I), may be applied simultaneously, i.e. synchronously. However, it is also possible first to employ the fertilizer and then the enaminocarbonyl compound, or first the enaminocarbonyl compound and then the fertilizer. In the case of nonsynchronous application of the enaminocarbonyl compound and the fertilizer, the application within the scope of the present invention is, however, carried out in a functional context, in particular within a period of from in general 24 hours, preferably 18 hours, especially preferably 12 hours, specifically 6 hours, more specifically 4 hours, even more specifically within 2 hours. In very special embodiments of the present invention, the application of the active substances according to the invention of the general formula (I) and of the fertilizer is carried out within a time frame of less than 1 hour, preferably less than 30 minutes, especially preferably less than 15 minutes.

Starting from at least one active substance to be used in accordance with the invention and at least one fertilizer, it is additionally possible to prepare dimensionally stable mixtures, for example in the form of rods, granules, tablets and the like. In order to prepare a suitable dimensionally stable mixture, the components in question can be mixed with one another and, if appropriate, extruded, or the fertilizer can be coated with the at least one active substance of the general formula (I) to be used in accordance with the invention. If appropriate, it is also possible to use formulation auxiliaries in the dimensionally stable mixtures, such as, for example, extenders or adhesives, in order to achieve a dimensional stability of the resulting mixture. As a result of the appropriate dimensional stability, such mixtures are suitable in particular for application in the home and garden sector, i.e. by a private user or hobby gardener, which can use the dimensionally stable mixture, or the components which are present therein, in a predetermined, precisely defined amount and without particular auxiliaries.

Independently of the above, the mixtures of at least one of the active substances to be used in accordance with the invention and the at least one fertilizer may also be present in liquid form, so that the resulting mixture can be applied as what is known as a tank mix, for example by a professional user in the agricultural sector.

Using at least one of the active substances to be used in accordance with the invention and at least one fertilizer makes it possible to increase root growth, which, in turn, makes possible a higher nutrient uptake, thereby promoting plant growth.

The active substances to be used in accordance with the invention, if appropriate in combination with fertilizers, can preferably be employed in the following plants, the enumeration which follows not being limiting.

Preferred plants are those from the group of the useful plants, ornamentals, turfs, generally used trees which are employed as ornamentals in the public and domestic sectors, and forestry trees. Forestry trees comprise trees for the production of timber, cellulose, paper and products made from parts of the trees.

The term useful plants as used in the present context refers to crop plants which are employed as plants for obtaining foodstuffs, feedstuffs, fuels or for industrial purposes.

The useful plants which can be improved with the method according to the invention include for example the following types of plants: turf, vines, cereals, for example wheat, barley, rye, oats, rice, maize and milletisorghum; beet, for example sugar beet and fodder beet; fruits, for example pome fruit, stone fruit and soft fruit, for example apples, pears, plums, peaches, almonds, cherries and berries, for example strawberries, raspberries, blackberries; legumes, for example beans, lentils, peas and soybeans; oil crops, for example oilseed rape, mustard, poppies, olives, sunflowers, coconuts, castor oil plants, cacao beans and peanuts; cucurbits, for example pumpkin/squash, cucumbers and melons; fibre plants, for example cotton, flax, hemp and jute; citrus fruit, for example, oranges, lemons, grapefruit and tangerines; vegetables, for example spinach, lettuce, asparagus, cabbage species, carrots, onions, tomatoes, potatoes and bell peppers; Lauraceae, for example avocado, Cinnamomum, camphor, or also plants such as tobacco, nuts, coffee, aubergine, sugarcane, tea, pepper, grapevines, hops, bananas, latex plants and ornamentals, for example flowers, shrubs, deciduous trees and coniferous trees. This enumeration is no limitation.

The following plants are considered to be particularly suitable target crops for applying the method according to the invention: cotton, aubergine, turf, pome fruit, stone fruit, soft fruit, maize, wheat, barley, cucumber, tobacco, vines, rice, cereals, pear, beans, soybeans, oilseed rape, tomato, bell pepper, melons, cabbage, potatoes and apples.

Examples of trees which can be improved in accordance with the method according to the invention are: Abies sp., Eucalyptus sp., Picea sp. Pinus sp., Aesculus sp., Platanus sp., Tilia sp., Acer sp., Tsuga sp., Fraxinus sp., Sorbus sp., Betula sp., Crataegus sp., Ulmus sp., Quercus sp., Fagus sp., Salix sp., Populus sp.

Preferred trees which can be improved in accordance with the method according to the invention are: from the tree species Aesculus: A. hippocastanum, A. pariflora, A. carnea; from the tree species Platanus: P. aceriflora, P. occidentalis, P. racemosa; from the tree species Picea: P. abies: from the tree species Pinus: P. radiate, P. ponderosa, P. contorta, P. sylvestre, P. elliottii, P. montecola, P. albicaulis, P. resinosa, P. palustris, P. taeda, P. flexilis, P. jeffregi, P. baksiana, P. strobes; from the tree species Eucalyptus: E. grandis, E. globulus, E. camadentis, E. nitens, E. obliqua, E. regnans, E. pilularus.

Especially preferred trees which can be improved in accordance with the method according to the invention are: from the tree species Pinus: P. radiate, P. ponderosa, P. contorta, P. sylvestre, P. strobes; from the tree species Eucalyptus: E. grandis, E. globulus, E. camadentis.

Very particularly preferred trees which can be improved in accordance with the method according to the invention are: horsechestnut, Platanaceae, linden tree, maple tree.

The present invention can also be applied to any turf grasses. including cool-season turf grasses and warm-season turf grasses. Examples of cold-season turf grasses are bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.) and bulbous bluegrass (Poa bulbosa L.); bentgrasses (Agrostis spp.) such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L. and Agrostis palustris Huds.), and redtop (Agrostis alba L.);

fescues (Festuca spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.) and meadow fescue (Festuca elanor L.);

ryegrasses (Lolium spp.), such as annual ryegrass (Lolium multiflorum Lam.), perennial ryegrass (Lolium perenne L.) and italian ryegrass (Lolium multiflorum Lam.);

and wheatgrasses (Agropyron spp.), such as fairway wheatgrass (Agropyron cristatum (L.) Gaertn.), crested wheatgrass (Agropvron desertorum (Fisch.) Schult.) and western wheatgrass (Agropyron smithii Rydb.).

Examples of further cool-season turfgrasses are beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristalus L.).

Examples of warm-season turfgrasses are Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz) and sideoats grama (Bouteloua curtipendula (Michx. Torr.). Cool-season turfgrasses are generally preferred for the use according to the invention. Especially preferred are bluegrass, benchgrass and redtop, fescues and ryegrasses. Bentgrass is especially preferred.

It has furthermore been found that enaminocarbonyl compounds of the general formula (I) leads to an increased expression of genes from the series of the pathogenesis-related proteins (PR proteins). PR proteins support the plants primarily in the defence against biotic stress factors such as, for example, phytopathogenic fungi, bacteria and viruses. As a consequence, plants are better protected from infection with phytopathogenic fungi, bacteria and viruses after the application of enaminocarbonyl compounds, in particular of enaminocarbonyl compounds of the general formula (I). Upon the necessary use of insecticides, fungicides and bactericides in a mixture and also in the sequential application together with enaminocarbonyl compounds, in particular with enaminocarbonyl compounds of the general formula (I), the activity of the former is supported.

The active compounds can be converted to the customary formulations, such as solutions, emulsions, wettable powders, water- and oil-based suspensions, powders, dusts, pastes, soluble powders, soluble granules, granules for broadcasting, suspension-emulsion concentrates, natural materials impregnated with active compound, synthetic materials impregnated with active compound, fertilizers and microencapsulations in polymeric substances.

These formulations are produced in a known manner, for example by mixing the active compounds with extenders, that is liquid solvents and/or solid carriers, optionally with the use of surfactants, that is emulsifiers and or dispersants and/or foam-formers. The formulations are prepared either in suitable plants or else before or during the application.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

Suitable solid carriers are:

for example, ammonium salts and ground natural minerals such as kaolins, clays, talc., chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POPPOE esters, alkyl aryl and/or POP-POE ethers, fat- and/or POP-POE adducts, POE and/or POP polyol derivatives, POE and/or POP sorbitan- or sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

Other possible additives are perfumes, mineral or vegetable, optionally modified oils, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

The formulations generally comprise between 0.01 and 98% by weight of active compound, preferably between 0.5 and 90%.

The active compound according to the invention can be present in its commercially available formulations and in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals.

The invention furthermore relates to the use of enaminocarbonyl compounds, in particular of enaminocarbonyl compounds of the general formula (I), for protecting plants against plant diseases which are caused by fungi, bacteria, viruses, MLOs (Mycoplasma-like organisms) and/or RLOs (Rickettsia-like organisms). Independently of an insect control, the enaminocarbonyl compounds lead to a good protection of the plant from damage by fungal, bacterial or viral pathogens.

Advantages over other methods which are possible are the low application rates required for achieving this protection, and the good plant tolerance of the enaminocarbonyl compound of the general formula (I). Moreover, a protection against a multiplicity of pathogens can be achieved with only one active substance.

To obtain protection from pathogens, the plants can be treated with individual active substances or with combinations of enaminocarbonyl compounds of the general formula (I), in particular against plant diseases which are caused by fungi, bacteria, viruses. MLOs (Mycoplasma-like organisms) and/or RLOs (Rickettsia-like organisms).

Furthermore, the positive activity which has been described of the enaminocarbonyl compounds on the plants' intrinsic defences can be supported by an additional treatment with insecticidal, fungicidal or bactericidal active substances.

In a preferred embodiment, this protection is effected by inducing PR proteins as the result of the treatment with enaminocarbonyl compounds of the general formula (I).

Preferred enaminocarbonyl compounds of the general formula (I) are:
(I-1), 4-{[(6-bromopyrid-3-yl)methyl](2-fluoroethyl)amino}furan-2(5H)-one
(I-2), 4-{[(6-bromopyrid-3-yl)methyl](2,2-difluoroethyl)amino}furan-2(5H)-one
(I-3), 4-{[(6-fluoropyrid-3-yl)methyl](2,2-difluoroethyl)amino}furan-2(5H)-one
(I-4), 4-{[(2-chloro-1,3-thiazol-5-yl)methyl](2-fluoroethyl)amino}furan-2(5H)-one
(I-5), 3-chloro-4-{[(6-chloropyrid-3-yl)methyl](2-fluoroethyl)amino}furan-2(5H)-one
(I-6), 4-{[(6-chloropyrid-3-yl)methyl](2-fluoroethyl)amino}furan-2(5H)-one
(I-7), 4-{[(6-chloropyrid-3-yl)methyl](2,2-difluoroethyl)amino}furan-2(5H)-one
(I-8), 4-{[(6-chloro-5-fluoropyrid-3-yl)methyl](methyl)amino}furan-2(5H)-one
(I-9), 4-{[(5,6-dichloropyrid-3-yl)methyl](cyclopropyl)amino}furan-2(5H)-one
(I-10), 4-{[(5,6-dichloropyrid-3-yl)methyl](methyl)amino}furan-2(5H)-one
(I-11), 4-{[(6-bromo-5-fluoropyrid-3-yl)methyl](methyl)amino}furan-2(5H)-one
(I-12), 4-{[(6-bromo-5-fluoropyrid-3-yl)methyl](cyclopropyl)amino}furan-2(5H)-one
(I-13), 4-{[(6-chloro-5-fluoropyrid-3-yl)methyl](cyclopropyl)amino}furan-2(5H)-one
(I-14), 4-{[(5,6-dichloropyrid-3-yl)methyl](2-fluoroethyl)amino}furan-2(5H)-one
(I-15), 4-{[(5,6-dichloropyrid-3-yl)methyl](2-fluoroethyl)amino}furan-2(5H)-one
(I-16), 4-{[(6-bromo-5-fluoropyrid-3-yl)methyl](2,2-difluoroethyl)amino}furan-2(5H)-one
(I-17), 4-{[(6-chloro-5-fluoropyrid-3-yl)methyl](2,2-difluoroethyl)amino}furan-2(5H)-one
(I-18), 3-{[(6-chloropyrid-3-yl)methyl](methyl)amino}cyclopent-2-en-1-one
(I-19), 3-{[(6-chloropyrid-3-yl)methyl](cyclopropyl)amino}cyclopent-2-en-1-one
(I-20), 4-{[(2-chloro-2,3-dihydro-1,3-thiazol-5-yl)methyl](methyl)amino}furan-2(5H)-one
(I-21), 4-[methyl(pyrid-3-ylmethyl)amino]furan-2(5H)-one
(I-22), 4-{cyclopropyl[(6-fluoropyrid-3-yl)methyl]amino}furan-2(5H)-one
(I-25), 4-{[(6-chloropyrid-3-yl)methyl](methyl)amino}-5-methyl furan-2(5H)-one
(I-29), 4-{[(6-chloropyrid-3-yl)methyl](methoxy)amino}furan-2(5H)-one
(I-31), 4-{[(6-chloropyrid-3-yl)methyl](cyclopropyl)amino}furan-2(5H)-one
(I-34), 4-{[(6-chloropyrid-3-yl)methyl](methyl)amino}furan-2(5H)-one
(I-35), 4-{[(6-chloropyrid-3-yl)methyl]amino}furan-2(5H)-one

Very especially preferred enaminocarbonyl compounds of the general formula (I) are:
(I-4), 4-{[(2-chloro-1,3-thiazol-5-yl)methyl](2-fluoroethyl)amino}furan-2(5H)-one
(I-5), 3-chloro-4-{[(6-chloropyrid-3-yl)methyl](2-fluoroethyl)amino}furan-2(5H)-one
(I-6), 4-{[(6-chloropyrid-3-yl)methyl](2-fluoroethyl)amino}furan-2(5H)-one
(I-7), 4-{[(6-chloropyrid-3-yl)methyl](2,2-difluoroethyl)amino}furan-2(5H)-one
(I-8), 4-{[(6-chloro-5-fluoropyrid-3-yl)methyl](methyl)amino}furan-2(5H)-one
(I-14), 4-{[(5,6-dichloropyrid-3-yl)methyl](2-fluoroethyl)amino}furan-2(5H)-one
(I-18), 3-{[(6-chloropyrid-3-yl)methyl](methyl)amino}cyclopent-2-en-1-one
(I-25), 4-{[(6-chloropyrid-3-yl)methyl](methyl)amino}-5-methyl furan-2(5H)-one
(I-29), 4-{[(6-chloropyrid-3-yl)methyl](methoxy)amino}furan-2(5H)-one
(I-31), 4-{[(6-chloropyrid-3-yl)methyl](cyclopropyl)amino}furan-2(5H)-one
(I-34), 4-{[(6-chloropyrid-3-yl)methyl](methyl)amino}furan-2(5H)-one

It is especially preferred to treat, in accordance with the invention, plants of the respective plant varieties which are commercially available or in use. Plant varieties are understood as meaning plants with novel properties (“traits”) which have been obtained by conventional breeding, by mutagenesis or else with the aid of recombinant DNA techniques. Accordingly, crop plants can be plants which can be obtained by conventional breeding and optimization methods or by biotechnological and recombinant methods or combinations of these methods, including the transgenic plants and including the plant varieties capable or not of being protected by Plant Breeders' Rights.

Thus, the treatment method according to the invention can also be used for the treatment of genetically modified organisms (GMOs), for example plants or seeds. Genetically modified plants (or transgenic plants) are plants in which a heterologous gene has been stably integrated into the genome. The term “heterologous gene” means essentially a gene which is provided or assembled outside the plant and which, upon introduction into the nuclear genome, the chloroplast genome or the mitochondrial genome, imparts to the transformed plant novel or improved agronomical or other traits, because it expresses a protein or polypeptide of interest or because another gene which is present in the plant, or other genes which are present in the plant, are down-regulated or switched off (for example by means of antisense technology, cosuppression technology or RNAi technology [RNA interference]). A heterologous gene which is present in the genome is also referred to as a transgene. A transgene, which is defined by its specific presence in the plant genome, is referred to as transformation event, or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active substances and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf colour, earlier flowering, higher quality and/or higher nutritional value of the harvested products, higher sugar concentration within the fruits, better storage stability and/or processability of the harvested products are possible, which exceed the effects which were actually to be expected.

At certain application rates, the active substance combinations according to the invention may also have a strengthening effect in plants. Accordingly, they are also suitable for mobilizing the defence system of the plant against attack by unwanted phytopathogenic fungi and/or microorganisms and/or viruses. This may, if appropriate, be one of the reasons for the enhanced activity of the combinations according to the invention, for example against fungi. Plant-strengthening (resistance-inducing) substances are to be understood as meaning, in the present context, those substances or combinations of substances which are capable of stimulating the defence system of plants in such a way that, when subsequently inoculated with unwanted phytopathogenic fungi and/or microorganisms and/or viruses, the treated plants display a substantial degree of resistance to these unwanted phytopathogenic fungi and/or microorganisms and/or viruses. In the present case, unwanted phytopathogenic fungi and/or microorganisms and/or viruses are to be understood as meaning phytopathogenic fungi, bacteria and viruses. Thus, the substances according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active substances.

Plants and plant varieties which are preferably to be treated according to the invention include all plants which have genetic material which imparts particularly advantageous, useful traits to these plants (whether obtained by breeding and/or biotechnological means).

Plants and plant varieties which are also preferably to be treated according to the invention are resistant against one or more biotic stress factors, i.e. said plants show a better defence against animal and microbial pests, such as against nematodes, insects, mites, phytopathogenic fungi, bacteria, viruses and/or viroids.

Plants and plant varieties which may also be treated according to the invention are those plants which are resistant to one or more abiotic stress factors. Abiotic stress conditions may include, for example, drought, cold temperature exposure, heat exposure, osmotic stress, waterlogging, increased soil salinity, increased mineral exposure, ozone exposure, high light exposure, limited availability of nitrogen nutrients, limited availability of phosphorus nutrients, shade avoidance.

Plants and plant varieties which may also be treated according to the invention are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including, but not limited to, early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and oil composition, nutritional value, reduction in anti-nutritional compounds, improved processability and better storage stability.

Plants that may be treated according to the invention are hybrid plants that already express the characteristic of heterosis, or hybrid effect, which results in generally higher yield, greater vigour, better health, and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in maize) be produced by detasseling (i.e. the mechanical removal of the male reproductive organs or male flowers) but, more typically, male sterility is the result of genetic determinants in the plant genome. In that case, and especially when seed is the desired product to be harvested from the hybrid plants it is typically useful to ensure that male fertility is fully restored in the hybrid plants which contain the determinants genetically responsible for male sterility. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacteria Salmonella typhimurium (Comai et al., Science (1983), 221, 370-371), the CP4 gene of the bacteria Agrobacterium sp. (Barry et al., Curt. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an eleusine EPSPS (WO 2001/66704). It can also be a mutated EPSPS as described in for example EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described in for example WO 2002/036782, WO 2003/092360, WO 2005/012515 and WO 2007/024782. Glyphosate-tolerant plants can also be obtained by selecting plants containing naturally-occurring mutations of the above-mentioned genes, as described in for example WO 2001/024615 or WO 2003/013226.

Other herbicide resistant plants are for example plants that are made tolerant to herbicides inhibiting the enzyme glutamine synthase, such as bialaphos, phosphinotricin or glufosinate. Such plants can be obtained by expressing an enzyme detoxifying the herbicide or a mutant glutamine synthase enzyme that is resistant to inhibition. One such efficient detoxifying enzyme is an enzyme encoding a phosphinotricin acetyltransferase (such as the bar or pat protein from Streptomyces species). Plants expressing an exogenous phosphinotricin acetyltransferase are for example described in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD inhibitors can be transformed with a gene encoding a naturally-occurring resistant HPPD enzyme, or a gene encoding a mutated HPPD enzyme as described in WO 1996/038567, WO 1999/024585 and WO 1999/024586. Tolerance for HPPD-inhibitors can also be obtained by transforming plants with genes encoding certain enzymes enabling the formation of homogentisate despite the inhibition of the native HPPD enzymes by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Still further herbicide resistant plants are plants that are made tolerant to acetolactate synthase (ALS) inhibitors. Known ALS inhibitors include, for example, sulphonylurea, imidazolinone, triazolopyrimidines, pyrimidinyloxy(thio)benzoates and/or sulphonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also, in U.S. Pat. No. 5,605,011, U.S. Pat. No. 5,378,824, U.S. Pat. No. 5,141,870 and U.S. Pat. No. 5,013,659. The production of sulphonylurea-tolerant plants and imidazolinone-tolerant plants is described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and in international publication WO 1996/033270. Other imidazolinone-tolerant plants are also described in for example WO 2004/040012, WO 2004/106529. WO 2005/020673, WO 2005/093093. WO 2006/007373. WO 2006/015376, WO 2006/024351 and WO 2006/060634. Further sulphonylurea- and imidazolinone-tolerant plants are also described in for example WO 2007/024782.

Other plants tolerant to imidazolinone and/or sulphonylurea can be obtained by induced mutagenesis, selection in cell cultures in the presence of the herbicide or mutation breeding as described for example for soybeans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) at the Bacillus thuringiensis toxin nomenclature, online at: http://www.lifesci.sussex.ac.uk/Hlome/Neil_Crickmore/Bt/), or insecticidal portions thereof, e.g., proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second crystal protein other than Bacillus thuringiensis or a portion thereof, such as the binary toxin made up of the Cy34 and Cy35 crystal proteins (Moellenbeck et al., Nat. Biotechnol. (2001), 19, 668-72. Schnepf et al., Applied Environm. Microb. (2006), 71, 1765-1774); or
3) a hybrid insecticidal protein comprising parts of different insecticidal crystal proteins from Bacillus thuringiensis, such as a hybrid of the proteins of 1) above or a hybrid of the proteins of 2) above, e.g., the Cry1A.105 protein produced by corn event MON98034 (WO 2007/027777); or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604; or
5) an insecticidal secreted protein from Bacillus thuringiensis or Bacillus cereus, or an insecticidal portion thereof, such as the vegetative insecticidal (VIP) proteins listed at: http://www.lifesci.sussex.ac.uk/Home/Neil_Crickmore/Bt/vip.html, e.g. proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102.

Of course, an insect-resistant transgenic plant, as used herein, also includes any plant comprising a combination of genes encoding the proteins of any one of the above classes 1 to 8. In one embodiment an insect-resistant plant contains more than one transgene encoding a protein of any one of the above classes 1 to 8, to expand the range of target insect species affected, or to delay insect resistance development to the plants by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stress factors. Such plants can be obtained by genetic transformation or by selection of plants containing a mutation imparting such stress resistance. Particularly useful stress tolerance plants include:
a. plants which contain a transgene capable of reducing the expression and/or the activity of the poly(ADP-ribose)polymerase (PARP) gene in the plant cells or plants as described in WO 2000/004173 or EP 04077984.5 or EP 06009836.5.
b. plants which contain a stress tolerance enhancing transgene capable of reducing the expression and/or the activity of the PARG encoding genes of the plants or plant cells, as described e.g. in WO 2004/090140.
c. plants which contain a stress tolerance enhancing transgene coding for a plant-functional enzyme of the nicotinamide adenine dinucleotide salvage biosynthetic pathway including nicotinamidase, nicotinate phosphoribosyltransferase, nicotinic acid mononucleotide adenyl transferase, nicotinamide adenine dinucleotide synthetase or nicotinamide phosphoribosyltransferase as described e.g. in EP 04077624.7 or WO 2006/133827 or PCT/EP07/002,433.

Plants or plant cultivars (obtained by plant biotechnology methods such as genetic engineering) which may also be treated according to the invention show altered quantity, quality and/or storage stability of the harvested product and/or altered properties of specific ingredients of the harvested product such as:
1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesized starch in wild type plant cells or plants, so that this modified starch is better suited for special applications. Said transgenic plants synthesizing a modified starch are disclosed, for example, in EP 0571427, WO 1995/004826, EP 0719338, WO 1996/15248, WO 1996/19581, WO 1996/27674, WO 1997/11188, WO 1997/26362 WO 1997/32985, WO 1997/42328, WO 1997/44472, WO 1997/45545, WO 1998/27212, WO 1998/40503, WO 99/58688, WO 1999/58690, WO 1999/58654, WO 2000/008184, WO 2000/008185, WO 2000/28052, WO 2000/77229, WO 2001/12782, WO 2001/12826, WO 2002/101059. WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862. WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, U.S. Pat. No. 6,734,341, WO 2000/11192, WO 1998/22604, WO 1998/32326, WO 2001/98509, WO 2001/98509, WO 2005/002359, U.S. Pat. No. 5,824,790, U.S. Pat. No. 6,013,861, WO 1994/004693, WO 1994/009144, WO 1994/11520, WO 1995/35026 or WO 1997/20936.
2) transgenic plants which synthesize non-starch carbohydrate polymers or which synthesize non-starch carbohydrate polymers with altered properties in comparison to wild type plants without genetic modification. Examples are plants producing polyfructose, especially of the inulin and levan type, as disclosed in EP 0663956, WO 1996/001904, WO 1996/021023, WO 1998/039460 and WO 1999/024593, plants producing alpha-1,4 glucans as disclosed in WO 1995/031553, US 2002/031826, U.S. Pat. No. 6,284,479, U.S. Pat. No. 5,712,107, WO 1997/047806, WO 1997/047807, WO 1997/047808 and WO 2000/14249, plants producing alpha-1,6 branched alpha-1,4 glucans, as disclosed in WO2000/73422, and plants producing alternan, as disclosed in WO 2000/047727, EP 06077301.7, U.S. Pat. No. 5,908,975 and EP 0728213.
3) transgenic plants which produce hyaluronan, as for example disclosed in WO 2006/032538, WO 2007/039314, WO 2007/039315, WO 2007/039316, JP 2006/304779 and WO 2005/012529.

Plants or plant cultivars (that can be obtained by plant biotechnology methods such as genetic engineering) which may also be treated according to the invention are plants, such as cotton plants, with altered fibre characteristics. Such plants can be obtained by genetic transformation or by selection of plants containing a mutation imparting such altered fibre characteristics and include:
a) plants, such as cotton plants, which contain an altered form of cellulose synthase genes as described in WO 1998/000549;
b) plants, such as cotton plants, which contain an altered form of rsw2 or rsw3 homologous nucleic acids as described in WO 2004/053219:
c) plants, such as cotton plants, with increased expression of sucrose phosphate synthase as described in WO 2001/017333;
d) plants, such as cotton plants, with increased expression of sucrose synthase as described in WO 02/45485;
e) plants, such as cotton plants, wherein the timing of the plasmodesmatal gating at the basis of the fibre cell is altered, e.g. through downregulation of fibre-selective β-1,3-glucanase as described in WO 2005/017157;
f) plants, such as cotton plants, which have fibres with altered reactivity, e.g. through the expression of the N-acetylglucosaminetransferase gene, including nodC, and of chitin synthase genes as described in WO 2006/136351.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation impairing such altered oil characteristics and include:
a) plants, such as oilseed rape plants, which produce oil having a high oleic acid content as described e.g. in U.S. Pat. No. 5,969,169, U.S. Pat. No. 5,840,946 or U.S. Pat. No. 6,323,392 or U.S. Pat. No. 6,063,947;
b) plants, such as oilseed rape plants, which produce oil having a low linolenic acid content as described in U.S. Pat. No. 6,270,828, U.S. Pat. No. 6,169,190 or U.S. Pat. No. 5,965,755;
c) plants, such as oilseed rape plants, which produce oil having a low level of saturated fatty acids as described e.g. in U.S. Pat. No. 5,434,283.

Particularly useful transgenic plants which may be treated according to the invention are plants which comprise one or more genes which encode one or more toxins and are the following which are sold under the trade names YIELD GARD® (for example maize, cotton, soybeans), KnockOut® (for example maize), BiteGard® (for example maize), BT-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soybean varieties which are sold under the trade names Roundup Ready® (tolerance to glyphosate, for example maize, cotton, soybean). Liberty Link® (tolerance to phosphinotricin, for example oilseed rape), IMI® (tolerance to imidazolinones) and SCS® (tolerance to sulphonylureas), for example maize. Herbicide-resistant plants (plants bred in a conventional manner for herbicide tolerance) which may be mentioned include the varieties sold under the name Clearfield® (for example maize).

Particularly useful transgenic plants which may be treated according to the invention are plants containing transformation events, or a combination of transformation events, that are listed for example in the databases from various national or regional regulatory agencies (see for example http://gmoinfo.jrc.it/gmp_browse.aspx and http://www.agbios.com/dbase.php).

Preferred enaminocarbonyl compounds of the general formula (I) for this application on transgenic plants and transgenic seed are:
(I-1), 4-{[(6-bromopyrid-3-yl)methyl](2-fluoroethyl)amino}furan-2(5H)-one
(I-2), 4-{[(6-bromopyrid-3-yl)methyl](2,2-difluoroethyl)amino}furan-2(5H)-one
(I-3), 4-{[(6-fluoropyrid-3-yl)methyl](2,2-difluoroethyl)amino}furan-2(5H)-one
(I-4), 4-{[(2-chloro-1,3-thiazol-5-yl)methyl](2-fluoroethyl)amino}furan-2(5H)-one
(I-5), 3-chloro-4-{[(6-chloropyrid-3-yl)methyl](2-fluoroethyl)amino}furan-2(5H)-one
(I-6), 4-{[(6-chloropyrid-3-yl)methyl](2-fluoroethyl)amino}furan-2(5H)-one
(I-7), 4-{[(6-chloropyrid-3-yl)methyl](2,2-difluoroethyl)amino}furan-2(5H)-one
(I-8), 4-{[(6-chloro-5-fluoropyrid-3-yl)methyl](methyl)amino}furan-2(5H)-one
(I-9), 4-{[(5,6-dichloropyrid-3-yl)methyl](cyclopropyl)amino}furan-2(5H)-one
(I-10), 4-{[(5,6-dichloropyrid-3-yl)methyl](methyl)amino}furan-2(5H)-one
(I-11), 4-{[(6-bromo-5-fluoropyrid-3-yl)methyl](methyl)amino}furan-2(5H)-one
(I-12), 4-{[(6-bromo-5-fluoropyrid-3-yl)methyl](cyclopropyl)amino}furan-2(5H)-one
(I-13), 4-{[(6-chloro-5-fluoropyrid-3-yl)methyl](cyclopropyl)amino}furan-2(5H)-one
(I-14), 4-{[(5,6-dichloropyrid-3-yl)methyl](2-fluoroethyl)amino}furan-2(5H)-one
(I-15), 4-{[(5,6-dichloropyrid-3-yl)methyl](2-fluoroethyl)amino}furan-2(5H)-one
(I-16), 4-{[(6-bromo-5-fluoropyrid-3-yl)methyl](2,2-difluoroethyl)amino}furan-2(5H)-one
(I-17), 4-{[(6-chloro-5-fluoropyrid-3-yl)methyl](2,2-difluoroethyl)amino}furan-2(5H)-one
(I-18), 3-{[(6-chloropyrid-3-yl)methyl](methyl)amino}cyclopent-2-en-1-one
(I-19), 3-{[(6-chloropyrid-3-yl)methyl](cyclopropyl)amino}cyclopcnt-2-en-1-one
(I-20), 4-{[(2-chloro-2,3-dihydro-1,3-thiazol-5-yl)methyl](methyl)amino}furan-2(5H)-one
(I-21), 4-[methyl(pyrid-3-ylmethyl)amino]furan-2(5H)-one
(I-22), 4-{-cyclopropyl[(6-fluoropyrid-3-yl)methyl]amino}furan-2(5H)-one
(I-25), 4-{[(6-chloropyrid-3-yl)methyl](methy)amino}-5-methylfuran-2(5H)-one
(I-29), 4-{[(6-chloropyrid-3-yl)methyl](methoxy)amino}furan-2(5H)-one
(I-31), 4-{[(6-chloropyrid-3-yl)methyl](cyclopropyl)amino}furan-2(5H)-one
(I-34), 4-{[(6-chloropyrid-3-yl)methyl](methyl)amino}furan-2(5H)-one
(I-35), 4-{[(6-chloropyrid-3-yl)methyl]amino}furan-2(5H)-one

Very especially preferred enaminocarbonyl compounds of the general formula (I) are:
(I-4), 4-{[(2-chloro-1,3-thiazol-5-yl)methyl](2-fluoroethyl)amino}furan-2(5H)-one
(I-5), 3-chloro-4-{[(6-chloropyrid-3-yl)methyl](2-fluoroethyl)amino}furan-2(5H)-one
(I-6), 4-{[(6-chloropyrid-3-yl)methyl](2-fluoroethyl)amino}furan-2(5H)-one
(I-7), 4-{[(6-chloropyrid-3-yl)methyl](2,2-difluoroethyl)amino}furan-2(5H)-one
(I-8), 4-{[(6-chloro-5-fluoropyrid-3-yl)methyl](methyl)amino}furan-2(5H)-one
(I-14), 4-{[(5,6-dichloropyrid-3-yl)methyl](2-fluoroethyl)amino}furan-2(5H)-one
(I-18), 3-{[(6-chloropyrid-3-yl)methyl](methyl)amino}cyclopent-2-en-1-one
(I-25), 4-{[(6-chloropyrid-3-yl)methyl](methyl)amino}-5-methylfuran-2(5H)-one
(I-29), 4-{[(6-chloropyrid-3-yl)methyl](methoxy)amino}furan-2(5H)-one
(I-31), 4-{[(6-chloropyrid-3-yl)methyl](cyclopropyl)amino}furan-2(5H)-one
(I-34), 4-{[(6-chloropyrid-3-yl)methyl](methyl)amino}furan-2(5H)-one

Within the scope of the present invention, the defence against the following pathogens is preferably enhanced: Botrytis cinerea, Phytophthora nicotianae, Peronospora tabacinae, Phytophthora infestans, Sphaerotheca fuliginea, Phakopsora pachyrhizi, Ramularia gossypii, Rhizoctonia solani, Curvularia spec., Pyrenophora spec., Sclerotinia homoeocarpa, Erysiphe graminis, Colletotrichum graminicola, Pythium ultimum, Pythium aphanidermatum.

Some pathogens which cause fungal and bacterial diseases and which come under the abovementioned generic terms may be mentioned by way of example, but not by limitation:
diseases caused by pathogens causing powdery mildew such as, for example,
Blumeria species such as, for example, Blumeria graminis;
Podosphaera species such as, for example, Podosphaera leucotricha;
Sphaerotheca species such as, for example, Sphaerotheca fuliginea:
Uncinula species such as, for example, Uncinula necator;
diseases caused by pathogens causing rust diseases such as, for example,
Gymnosporangium species such as, for example, Gymnosporangium sabinae
Hemileia species such as, for example, Hemileia vastatrix;
Phakopsora species such as, for example, Phakopsora pachyrhizi and Phakopsora meibomiae;
Puccinia species such as, for example, Puccinia recondita;
Uromyces species such as, for example, Uromyces appendiculatus;
diseases caused by pathogens from the Oomycetes group such as, for example,
Bremia species such as, for example, Bremia lactucae;
Peronospora species such as, for example, Peronospora pisi or P. brassicae;
Phytophthora species such as, for example, Phytophthora infestans;
Plasmopara species such as, for example, Plasmopara viticola;
Pseudoperonospora species such as, for example, Pseudoperonospora humuli or Pseudoperonospora cubensis;
Pythium species such as, for example, Pythium ultimum:
leaf spot diseases and foliar wilts caused by, for example,
Alternaria species such as, for example. Alternaria solani;
Cercospora species such as, for example, Cercospora beticola;
Cladiosporum species such as, for example, Cladiosporium cucumerinum;
Cochliobolus species such as, for example, Cochliobolus sativus
(conidial form: Drechslera, syn: Helminthosporium);
Colletotrichum species such as, for example, Colletotrichum lindemuthanium;
Cycloconium species such as, for example, Cycloconium oleaginum;
Diaporthe species such as, for example. Diaporthe citri;
Elsinoe species such as, for example, Elsinoe fawcettii;
Gloeosporium species such as, for example, Gloeosporium laeticolor;
Glomerella species such as, for example, Glomerella cingulata;
Guignardia species such as, for example, Guignardia bidwelli;
Leptosphaeria species such as, for example, Leptosphaeria maculans;
Magnaporthe species such as, for example, Magnaporthe grisea;
Mycosphaerella species such as, for example. Mycosphaerella graminicola and Mycosphaerella fijiensis;
Phaeosphaeria species such as, for example, Phaeosphaeria nodorum;
Pyrenophora species such as, for example, Pyrenophora teres;
Ramularia species such as, for example, Ramularia collo-cygni;
Rhynchosporium species such as, for example, Rhynchosporium secalis;
Septoria species such as, for example, Septoria apii;
Typhula species such as, for example, Typhula incarnata;
Venturia species such as, for example. Venturia inaequalis;
root and stem diseases caused by, for example,
Corticium species such as, for example, Corticium graminearum;
Fusarium species such as, for example, Fusarium oxysporum;
Gaeumannomyces species such as, for example, Gaeumannomyces graminis;
Rhizoctonia species such as, for example, Rhizoctonia solani;
Tapesia species such as, for example, Tapesia acuformis;
Thielaviopsis species such as, for example, Thielaviopsis basicola:
ear and panicle diseases (including maize cobs), caused by, for example,
Alternaria species such as, for example. Alternaria spp.;
Aspergillus species such as, for example, Aspergillus flavus;
Cladosporium species such as, for example, Cladosporium spp.;
Claviceps species such as, for example, Claviceps purpurea;
Fusarium species such as, for example, Fusarium culmorum:
Gibberella species such as, for example, Gibberella zeae;
Monographella species such as, for example, Monographella nivalis:
diseases caused by smuts such as, for example,
Sphacelotheca species such as, for example, Sphacelotheca reiliana;
Tilletia species such as, for example, Tilletia caries;
Urocystis species such as, for example, Urocystis occulta;
Ustilago species such as, for example, Ustilago nuda;
fruit rot caused by, for example,
Aspergillus species such as, for example, Aspergillus flavus.
Botrytis species such as, for example, Botrytis cinerea;
Penicillium species such as, for example, Penicillium expansum and Penicillium purpurogenum;
Sclerotinia species such as, for example, Sclerotinia sclerotiorum;
Verticilium species such as, for example, Verticilium alboatrum;
seed- and soil-borne rots and wilts, and seedling diseases, caused by, for example,
Alternaria species such as, for example, Alternaria brassicicola;
Aphanomyces species such as, for example, Aphanomyces euteiches:
Ascochyta species such as, for example, Ascochyta lentis;
Aspergillus species such as, for example, Aspergillus flavus;
Cladosporium species such as, for example, Cladosporium herbarum;
Cochliobolus species such as, for example, Cochliobolus sativus;
(conidial form: Drechslera. Bipolaris syn: Helminthosporium);
Colletotrichum species such as, for example, Colletotrichum coccodes;
Fusarium species such as, for example, Fusarium culmorum;
Gibberella species such as, for example, Gibberella zeac;
Macrophomina species such as, for example, Macrophomina phaseolina;
Monographella species such as, for example, Monographella nivalis;
Penicillium species such as, for example, Penicillium expansum;
Phoma species such as, for example, Phoma lingam;
Phomopsis species such as, for example, Phomopsis sojae;
Phytophthora species such as, for example, Phytophthora cactorum;
Pyrenophora species such as, for example, Pyrenophora graminea:
Pyricularia species such as, for example, Pyricularia oryzae;
Pythium species such as, for example, Pythium ultimum:
Rhizoctonia species such as, for example, Rhizoctonia solani;
Rhizopus species such as, for example. Rhizopus oryzae;
Sclerotium species such as, for example, Sclerotium rolfsii;
Septoria species such as, for example, Septoria nodorum;
Typhula species such as, for example, Typhula incarnata;
Verticillium species such as, for example, Verticillium dahliae;
cankers, galls and witches' brooms, caused by, for example,
Nectria species such as, for example, Nectria galligena;
wilts caused by, for example,
Monilinia species such as, for example, Monilinia laxa;
deformations of leaves, flowers and fruits, caused by, for example,
Taphrina species such as, for example, Taphrina deformans;
degenerative diseases of woody species, caused by, for example.
Esca species such as, for example, Phaemoniella clamydospora and Phaeoacremonium aleophilum and Fomitiporia mediterranea;
flower and seed diseases caused by, for example,
Botrytis species such as, for example, Botrytis cinerea;
diseases of plant tubers caused by, for example,
Rhizoctonia species such as, for example, Rhizoctonia solani;
Helminthosporium species such as, for example, Helminthosporium solani;
diseases caused by bacterial pathogens such as, for example,
Xanthomonas species such as, for example, Xanthomonas campestris pv. oryzae;
Pseudomonas species such as, for example, Pseudomonas syringae pv. lachrymans:
Erwinia species such as, for example, Erwinia amylovora;

The following diseases of soybeans can preferably be controlled:

fungal diseases on leaves, stems, pods and seeds caused by, for example,

alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola)

fungal diseases on roots and at the stem base caused by, for example.

black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum. Fusarium equiseti), mycoleptodiscus root rot (Mycoleptodiscus terrestris). neocosmospora (Neocosmopspora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

Preferred points in time for the application of enaminocarbonyl compounds for the purposes of pathogen defence are treatments of the seed, the soil, the nutrient solutions, the stems and/or the leaves with the approved application rates.

In order to achieve the properties according to the invention, the amounts of an enaminocarbonyl compound can be varied within a substantial range. To achive an effect, it is preferred to use concentrations of from 0.00001% to 0.05%, especially preferably of from 0.000025% to 0.025% and very especially preferably of from 0.000025% to 0.005%. When mixtures are employed, the concentration of the active substance combinations is preferably between 0.000025% and 0.005%, especially preferably between 0.00005% and 0.001%. The data given hereinbelow and hereafter are, unless otherwise specified, percent by weight.

To enhance plants' intrinsic defences and/or to improve plant growth and/or to increase the resistance of plants to plant diseases, the active substances according to the invention may also be employed in the treatment of seed. Active substances to be mentioned by preference in this context are in particular those mentioned above as being preferred, especially preferred and very especially preferred. In this respect, the compounds of the general formulae (I-a) to (I-d) and the specific compounds of the formulae (I-1) to (I-46) must be mentioned in particular.

The majority of the damage caused on crop plants is generated as early as during the seed state during storage and after the seed has been introduced into the soil, and during and immediately after the germination of the plants. This phase is particularly critical since the roots and shoots of the grown plant are especially sensitive, and even a small amount of damage can lead to the dying of the whole plant. There exists, therefore, a great deal of interest in enhancing the plants' intrinsic defences of the seed, in supporting plant growth, in increasing the resistance of the seed and of the seedling to plant diseases, in other words, therefore, in protecting the germinating plant by using suitable means.

The treatment of the seed of plants has been known for a long time and is the subject of continuous improvement. However, the treatment of seed poses a series of problems which cannot always be solved in a satisfactory manner. Thus, it is desirable to develop methods of protecting the seed and the germinating plant which dispense with the additional application of plant protection compositions or of compositions for improving plant growth and for increasing the resistance of plants to plant diseases caused by fungi, bacteria, viruses, MLOs and/or RLOs after sowing or after the emergence of the plants. It is furthermore desirable to optimize the amount of the active substance employed in such a way as to provide the best possible protection for the seed and the germinating plant without, however, damaging the plant itself by the active substance employed.

The present invention therefore especially also relates to a method of protecting seed and germinating plants for improving plant growth and/or for increasing the resistance of plants to plant diseases caused by fungi, bacteria, viruses, MLOs and/or RLOs, by treating the seed and/or the germinating plant with an active substance according to the invention. The invention also relates to the corresponding use of the active substances according to the invention for the treatment of seed. The invention furthermore relates to seed which has been treated with an active substance according to the invention.

Moreover, the present invention also relates to corresponding nutrient solutions, in particular for growing plants and/or germinating plants, comprising an amount of at least one enaminocarbonyl compound, in particular of an enaminocarbonyl compound of the general formula (I), which is effective for increasing plants' intrinsic defences and/or for improving plant growth and/or for increasing the resistance of plants to plant diseases caused by fungi, bacteria, viruses, MLOs (mycoplasma-like organisms) and/or RLOs (rickettsia-like organisms). In this context, the nutrient solutions preferably contain the at least one enaminocarbonyl compound in an amount of from 0.0005 to 0.025% by weight, based on the total weight of the nutrient solution. In a preferred embodiment, the at least one enaminocarbonyl compound is present in the form of an NMP-free formulation comprising 10 to 50% by weight of propylene carbonate.

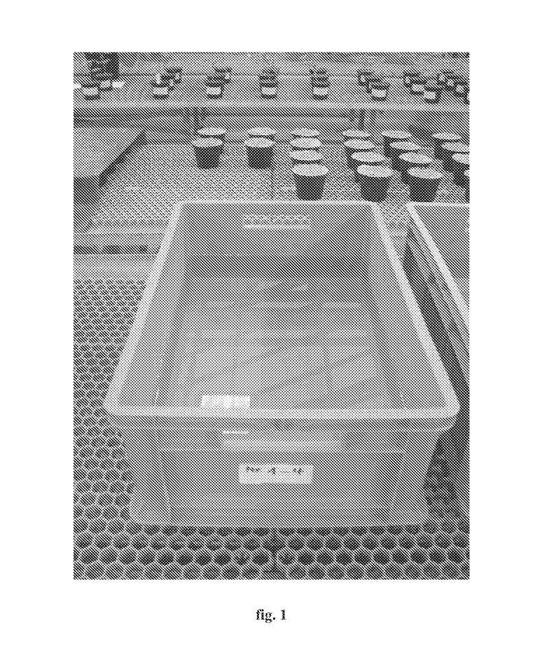

In a preferred embodiment, the method of protecting seed and germinating plants for improving plant growth and/or for increasing the resistance of plants to plant diseases caused by fungi, bacteria, viruses. MLOs and/or RLOs is carried out by growing the seed together with an active substance according to the invention in what is known as the float method or floating method (Leal, R. S., The use of Confidor S in the float, a new tobacco seedlings production system in the South of Brazil Pflanzenschutz-Nachrichten Bayer (German edition) (2001), 54(3), pages 337 to 352; Rudolph, R. D.; Rogers, W. D.; The efficacy of imidacloprid treatment for reduction in the severity of insect vectored virus diseases of tobacco. Pflanzenschutz-Nachrichten Bayer (German edition) (2001), 54(3), pages 311 to 336.). In this method, the seed is sown in specific containers, for example perforated Styropor trays, in specific seed compost based on peat medium, and subsequently cultured in containers with a suitable nutrient solution until the desired transplant size has been reached (cf. FIG. 1). Here, the containers are allowed to float on the nutrient solution, which gives the cultivation method its name (Leal, 2001, see above). In floating methods, insecticides from the neonicotinoid (chloronicotinyl) class have been employed for some years for controlling certain insects.

The floating method is explained in greater detail with the aid of the appended FIGS. 1 to 3.

It is one of the advantages of the present invention that, due to the particular systemic properties of the active substances according to the invention, the treatment of the seed with these active substances protects not only the seed itself, but also the plants which it generates after emergence in such a way that the growth of the plants is enhanced and the resistance of plants to plant diseases caused by fungi, bacteria, viruses, MLOs and/or RLOs is increased. Thus, the direct treatment of the crop at the point of sowing or shortly thereafter can be dispensed with.

Another advantage is that the mixtures according to the invention can also be employed in particular for transgenic seed.

The compositions according to the invention are suitable for the protection and support of seed of any plant variety as already mentioned above which is employed in agriculture, in the greenhouse, in afforestation or in horticulture. In particular, this takes the form of seed of maize, peanut, canola, oilseed rape, poppy, soya, cotton, beet (for example sugar beet and fodder beet), rice, sorghum and millet, wheat, barley, oats, rye, sunflower, tobacco, potatoes or vegetables (for example tomatoes, brassicas). The active substances to be used according to the invention are also suitable for the treatment of the seed of fruit plants or vegetables. Particularly important is the treatment of the seed of maize, soya, cotton, wheat and canola or oilseed rape.

As already mentioned above, the treatment of transgenic seed with a composition according to the invention is also particularly important.

Within the scope of the present invention, the active substances according to the invention are applied to the seed either alone or in the form of a suitable formulation. The seed is preferably treated in a state in which it is sufficiently stable to avoid damage during the treatment. In general, treatment of the seed can be effected at any point in time between harvest and sowing. Usually, seed is used which has been separated from the plant and freed from cobs, hulls, stems, coats, hair or pulp.

When treating seed, care must be taken generally that the amount of the active substances according to the invention and/or further additives which is/are applied to the seed is chosen in such a way that the germination of the seed is not adversely affected, or the plant which the seed gives rise to is not damaged. This is in particular the case for active substances which may have phytotoxic effects at certain application rates.

The compositions according to the invention can be applied directly, which means without comprising further components and without having been diluted. As a rule, it is preferable to apply the compositions to the seed in the form of a suitable formulation. Suitable formulations and methods for the treatment of seed are known to the skilled worker and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active substances which can be used in accordance with the invention can be converted into the customary seed-dressing formulations, such as solutions, emulsions, suspensions, powders, foams, slurries or other coating compositions for seed, and ULV formulations.

These formulations are prepared in a known manner by mixing the active substances according to the invention with customary additives such as, for example, customary extenders and solvents or diluents, colorants, wetters, dispersants, emulsifiers, antifoams, preservatives, secondary thickeners, adhesives, gibberellins, and also water.

Colorants which may be present in the seed-dressing formulations which can be used in accordance with the invention are all colorants which are customary for such purposes. In this context, not only pigments, which are sparingly soluble in water, but also dyes, which are soluble in water, may be used. Examples which may be mentioned are the colorants known as Rhodamin B, C.I. Pigment Red 112 and C.I. Solvent Red 1.

Wetters which may be present in the seed-dressing formulations which can be used in accordance with the invention are all those substances which promote wetting and which are customary in the formulation of agrochemical active substances. The following can preferably be used: alkylnaphthalene sulphonates, such as diisopropyl- or diisobutylnaphthalene sulphonates.

Dispersants and/or emulsifiers which may be present in the seed-dressing formulations which can be used in accordance with the invention are all those nonionic, anionic and cationic dispersants which are customary in the formulation of agrochemical active substances. The following can preferably be used: nonionic or anionic dispersants or mixtures of nonionic or anionic dispersants. Suitable nonionic dispersants are, in particular, ethylene oxide/propylene oxide block polymers, alkylphenol polyglycol ethers and tristryrylphenol polyglycol ether, and their phosphated or sulphated derivatives. Suitable inorganic dispersants are, in particular, lignosulphonates, polyacrylic acid salts and arylsulphonate/formaldehyde condensates.

Antifoams which can be used in the seed-dressing formulations which can be used in accordance with the invention are all those foam-inhibitory substances which are customary in the formulations of agrochemical active substances. Silicone antifoams and magnesium stearate can preferably be used.

Preservatives which can be used in the seed-dressing formulations which can be used in accordance with the invention are all substances which can be used for such purposes in agrochemical compositions. Examples which may be mentioned are dichlorophene and benzyl alcohol hemiformal.

Secondary thickeners which can be used in the seed-dressing formulations which can be used in accordance with the invention are all substances which can be used for such purposes in agrochemical compositions. The following are preferably suitable: cellulose derivatives, acrylic acid derivatives, xanthan, modified clays and highly-disperse silica.

Adhesives which may be present in the seed-dressing formulations which can be used in accordance with the invention are all customary binders which can be employed in seed-dressing products. The following may be mentioned by preference: polyvinylpyrrolidone, polyvinyl acetate, polyvinyl alcohol and tylose.

Gibberellins which may be present in the seed-dressing formulations which can be used in accordance with the invention are preferably the gibberellins A1, A3 (=gibberellic acid), A4 and A7, with gibberellic acid being especially preferably used. The gibberellins are known (cf. R. Wegler “Chemie der Pflanzenschutz-und Schidlingsbekampfungsmittel” [Chemistry of Crop Protectants and Pesticides], Vol. 2, Springer Verlag, 1970, p. 401-412).

The seed-dressing formulations which can be used for the treatment of a wide range of seed, including the seed of transgenic plants, in accordance with the invention can be employed either directly or after previously having been diluted with water.

All mixing apparatuses which can be employed for dressing seed are suitable for treating seed with the seed-dressing formulations which can be used in accordance with the invention or the preparations prepared therefrom by addition of water. Specifically, a procedure is followed for the seed-dressing process in which the seed is introduced into a mixer, the specific required amount of seed-dressing formulation, either as such or after having previously been diluted with water, is added, and everything is mixed until the formulation has been distributed uniformly on the seed. If appropriate, this is followed by a drying process.

In general, the active substances according to the invention may additionally be present, in their commercially available formulations and in the use forms prepared from these formulations, as mixtures with other active substances, such as insecticides, attractants, sterilants, acaricides, nematicides, fungicides, growth-regulating substances or herbicides.

Particularly advantageous mixing partners are, for example, the following:

### Fungicides:

Nucleic acid synthesis inhibitors

benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid

Mitosis and cell division inhibitors

benomyl, carbendazim, diethofencarb, fuberidazole, pencycuron, thiabendazole, thiophanate-methyl, zoxamide

Respiratory chain inhibitors complex I/II

diflumetorim

bixafen, boscalid, carboxin, fenfuram, fluopyram, flutolanil, furametpyr, mepronil, oxycarboxin, penthiopyrad, thifluzamide, N-[2-(1,3-dimethylbutyl)phenyl]-5-fluoro-1,3-dimethyl-1H-pyrazole-4-carboxamide

Respiratory chain inhibitors complex III

amisulbron, azoxystrobin, cyazofamid, dimoxystrobin, enestrobin, famoxadone, fenamidone, fluoxastrobin, kresoxim-methyl, metominostrobin, orysastrobin, pyraclostrobin, pyribencarb, picoxystrobin, trifloxystrobin

Decouplers

dinocap, fluazinam

ATP production unhibitors

fentin acetate, fentin chloride, fentin hydroxide, silthiofam

Amino acid and protein biosynthesis inhibitors

andoprim, blasticidin-S, cyprodinil, kasugamycin, kasugamycin hydrochloride hydrate, mepanipyrim, pyrimethanil

Signal transduction inhibitors

fenpiclonil, fludioxonil, quinoxyfen

Lipid and membrane synthesis inhibitors

chlozolinate, iprodione, procymidone, vinclozolin

ampropylfos, ampropylfos-potassium, edifenphos, iprobenfos (IBP), isoprothiolan, pyrazophos tolclofos-methyl, biphenyl

iodocarb, propamocarb, propamocarb hydrochloride

Ergosterol biosynthesis inhibitors

fenhexamid,

azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, spiroxamin, tebuconazole, tetraconazole, triadimefon, triadimenol, triticonazole, uniconazole, voriconazole, imazalil, imazalil sulphate, oxpoconazole, fenarimol, flurprimidole, nuarimol, pyrifenox, triforin, pefurazoate, prochloraz, triflumizole, viniconazole,

aldimorph, dodemorph, dodemorph acetate, fenpropimorph, tridemorph, fenpropidine, spiroxamine,

naftifin, pyributicarb, terbinafin

Cell wall synthesis inhibitors

benthiavalicarb, bialaphos, dimethomorph, flumorph, iprovalicarb, polyoxins, polyoxorim, validamycin A

Melanin biosynthesis inhibitors

carpropamid, diclocymet, fenoxanil, phthalide, pyroquilon, tricyclazole

Resistance induction

acibenzolar-S-methyl, probenazole, tiadinil

Multi-site

captafol, captan, chlorothalonil, copper salts such as copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram

Unknown mechanism

amibromdol, benthiazole, bethoxazin, capsimycin, carvone, quinomethionate, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fluopicolide, fluoroimide, fosatyl-A1, hexachlorobenzene, 8-hydroxyquinoline sulphate, iprodione, irumamycin, isotianil, methasulphocarb, metrafenon, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrroInitrine, quintozene, tecloftalam, tecnazene, triazoxide, trichlamide, zarilamide and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]-ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinecarbonitrile, methyl 2-[[[cyclopropyl[(4-methoxyphenyl)imino]methyl]thio]methyl]-.alpha.-(methoxymethylene)benzoacetate, 4-chloro-alpha-propynyloxy-N-[2-[3-methoxy-4-(2-propynyloxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulphonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1V)-1,2,2-trimethylpropyl][1,2,4]triazolo[1,5-a]pyrimidine-7-amine, 5-chloro-N-[[(1R)-1,2-dimethylpropyl]-6-(2,4,6-trifluorophenyl)[1,2,4]triazolo[1,5-a]pyrimidine-7-amine. N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyllbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethyl ideneJamino]oxy]methyl]-alpha-(methoxyimino)-N-methyl-alpha-E-benzoacetamide, N-{2-[3-chloro-5-(trifluoromethyl)pyridin-2-yl]ethyl}-2-(trifluoromethyl)benzamide, N-(3′,4-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1H-carboxylic acid, O-[1-[(4-methoxyphenoxy)methyl]-2,2-dimethylpropyl]-1H-imidazole-1H-carbothioic acid, 2-(2-{[6-(3-chloro-2-methylphenoxy)-5-fluoropyrimidin-4-yl]oxy}phenyl)-2-(methoxyimino)-N-methylacetamide

### Bactericides:

Bronopol, dichlorophen, nitrapyrin, nickel dimethyl dithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

Acetylcholine esterase (AChE) inhibitors

Carbamates,

for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, fenoxycarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate

Organophosphates,

for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formo-thion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

Sodium channel modulators/voltage-dependent sodium channel blockers

Pyrethroids,

for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)

DDT

Oxadiazines,

for example indoxacarb

Semicarbazone,

for example metaflumizon (BAS3201)

Acetylcholine receptor agonists/antagonists

Chloronicotinyls,

for example acetamiprid, AKD 1022, clothianidin, dinotefuran, imidacloprid, imidaclothiz, nitenpyram, nithiazine, thiacloprid, thiamunethoxam

Nicotine, bensultap, cartap

Acetylcholine receptor modulators

Spinosyns,

for example spinosad or spinetoram (ISO-proposed: XDE-175, known from WO 97/00265 A1, U.S. Pat. No. 6,001,981 and Pest Manag. Sci. 57, 177-185, 2001),

GABA-controlled chloride channel antagonists

Organochlorines,

for example camphechlor, chlordane, endosulfan, gamma-HCl, HCH, heptachlor, lindane, methoxychlor

Fiproles,

for example acetoprole, ethiprole, fipronil, pyrafluprole, pyriprole, vaniliprole

Chloride channel activators

Mectins,

for example abamectin, emamectin, emamectin benzoate, ivermectin, lepimectin, milbemycin

Juvenile hormone mimetics,

for example diofenolan, epofenonane, fenoxycarb, hydroprene, kinoprene, methoprene, pyriproxifen, triprene

Ecdysone agonists/disruptors

Diacylhydrazines,

for example chromafenozide, halofenozide, methoxyfenozide, tebufenozide

Chitin biosynthesis inhibitors

Benzoylureas,

for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
Buprofezin
Cyromazine

Inhibitors of oxidative phosphorylation, ATP disruptors
Diafenthiuron
Organotins,
for example azocyclotin, cyhexatin, fenbutatin oxide

Uncouplers of oxidative phosphorylation by interrupting the H-proton gradient

Pyrroles,

for example chlorfenapyr

Dinitrophenols.

for example binapacyrl, dinobuton, dinocap, DNOC, meptyldinocap

Site-I electron transport inhibitors

METIs,

for example fenazaquin, fenpyroximate, pyrimidifen, pyridaben, tebufenpyrad, tolfenpyrad
Hydramethylnon
Dicofol

Site-II electron transport inhibitors

Rotenone

Site-III electron transport inhibitors

Acequinocyl, fluacrypyrim

Microbial disruptors of the insect gut membrane

Bacillus thuringiensis strains

Fat biosynthesis inhibitors

Tetronic acids,

for example spirodiclofen, spiromesifen

Tetramic acids.

for example spirotetramate, cis-3-(2,5-dimethylphenyl)-4-hydroxy-8-methoxy-1-azaspiro[4.5]dec-3-en-2-one
Carboxamides,
for example flonicamid
Octopaminergic agonists,
for example amitraz

Inhibitors of magnesium-stimulated ATPase
propargite
Nereistoxin analogues,
for example thiocyclam hydrogen oxalate, thiosultap sodium

Ryanodin receptor agonists,
benzoic dicarboxamides,
for example flubendiamide,
anthranilamides.

for example rynaxypyr (3-bromo-N-{4-chloro-2-methyl-6-[(methylamino)carbonyl]phenyl}-1-(3-chloropyridin-2-yl)-1H-pyrazole-5-carboxamide), cyazypyr (ISO-proposed) (3-bromo-N-{4-cyano-2-methyl-6-[(methylamino)carbonyl]phenyl}-1-(3-chloropyridin-2-yl)-1H-pyrazole-5-carboxamide) (known from WO 2004067528)

Biologicals, hormones or pheromones

for example azadirachtin. Bacillus spec., Beauveria spec., codlemone, Metarrhizium spec., Paecilomyces spec., thuringiensin, Verticillium spec.

Active substances with unknown or unspecific mechanisms of action

Fumigants.

for example aluminium phosphide, methyl bromide, sulphuryl fluoride

Antifeedants,

for example cryolite, flonicamid, pymetrozine

Mite growth inhibitors,

for example clofentezine, etoxazole, hexythiazox

Amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnon, japonilure, metoxadiazone, petroleum, piperonyl butoxide, potassium oleate, pyridalyl, sulfluramid, tetradifon, tetrasul, triarathene, verbutin or lepimectin.

### DESCRIPTION OF THE FIGURES

FIG. 1: Floating Box filled with nutrient solution.

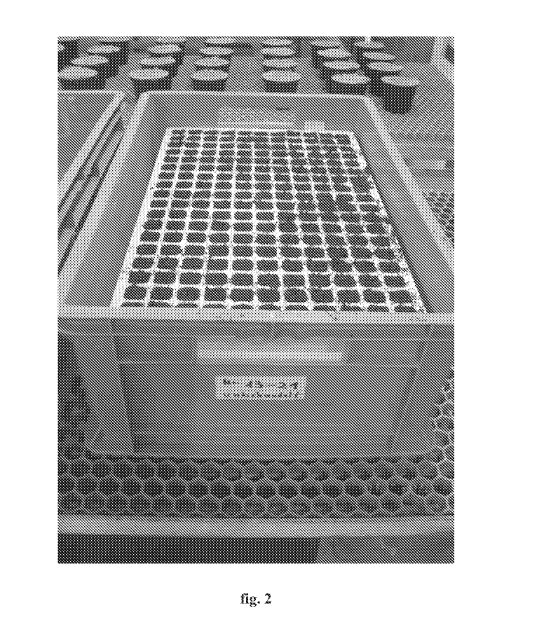

FIG. 2: Floating Box with floating Styropor culture dishes filled with seedling compost and tobacco seeds.

FIG. 3: Styropor culture dishes with tobacco plants after growing in a floating box.

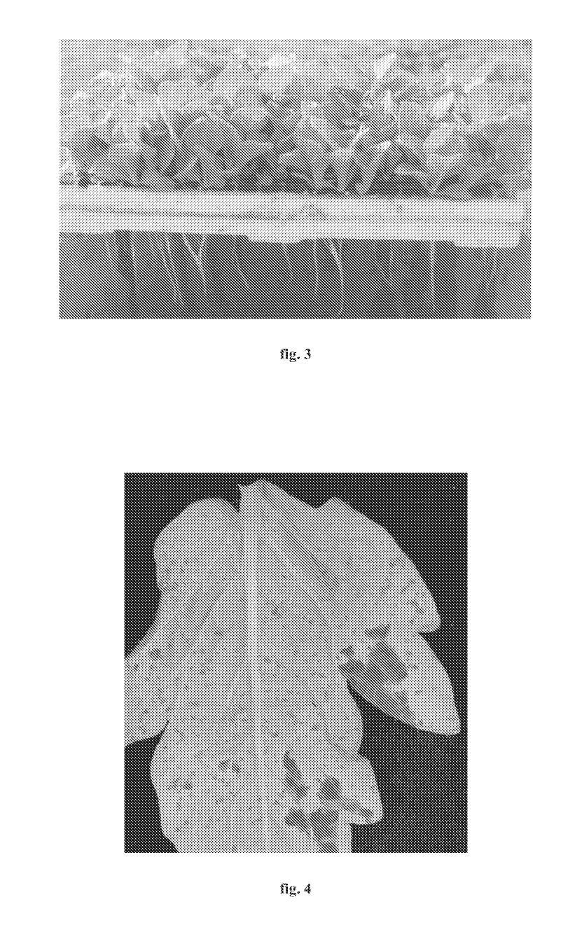

FIG. 4: Leaf of a tomato plant inoculated with Botrytis cinerea, treated with Fluopyram, 20 mg/plant.

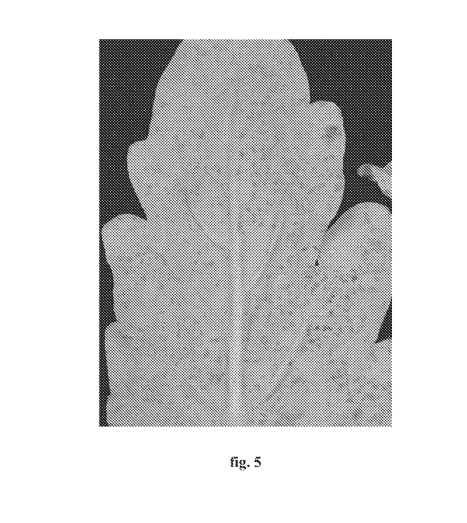

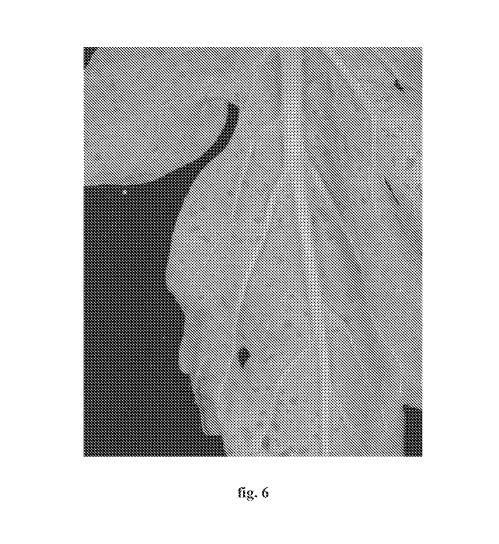

FIG. 5: Leaf of a tomato plant inoculated with Borryris cinerea, treated with Fluopyram, 20 mg/plant and compound I-7, 10 mg/plant.

FIG. 6: Leaf of a tomato plant inoculated with Botrvtis cinerea, treated with Fluopyram, 20 mg/plant and compound I-34, 10 mg/plant

The examples which follow describe the invention in detail, but do not limit the present invention in any way.

### Example 1

### Drench Application of Enaminocarbonyl Compounds of the Formula (I) According to the Invention in Combination with a Fungicide for Controlling Botrytis cinerea (Grey Mould) on Tomatoes/Comparison with the Fungicide-Only Treatment

To control Botrytis cinerea (grey mould) on tomatoes, tomato plants which had been grown in peaty soil were treated with the compounds I-34 or I-7 alone or in combination with the fungicide fluopyram (drench application) 5 or 10 days before being inoculated with Botrvtis cinerea.

TABLE 1

| No. | Treatment | Dose | Application |
|---|---|---|---|
| 1 | Untreated | | |
| | control; | | |
| | inoculated | | |
| 2 | Compound | 10 mg a.i./plant | Drench application, |
| | I-34 | | 5 days before inoculation |
| 3 | Compound | 10 mg a.i./plant | Drench application, |
| | I-34 | | 5 days before inoculation |
| | fluopyram | 20 mg a.i./plant | Drench application, |
| | | | 5 days before inoculation |
| 4 | Compound | 10 mg a.i/plant | Drench application, |
| | I-34 | | 5 days before inoculation |
| | fluopyram | 20 mg a.i./plant | Drench application, |
| | | | 10 days before inoculation |
| 5 | Compound | 10 mg a.i./plant | Drench application, |
| | I-7 | | 5 days before inoculation |
| 6 | Compound | 10 mg a.i./plant | Drench application, |
| | I-7 | | 5 days before inoculation |
| | fluopyram | 20 mg a.i./plant | Drench application, |
| | | | 10 days before inoculation |
| 7 | Compound | 10 mg a.i./plant | Drench application, |
| | I-7 | | 5 days before inoculation |
| | fluopyram | 20 mg a.i./plant | Drench application, |
| | | | 10 days before inoculation |
| 8 | Fluopyram | 20 mg a.i./plant | Drench application, |
| | | | 5 days before inoculation |

The inoculation with Botrytis cinerea was carried out at the stated points in time (5 or 10 days after drench application of compound I-34, I-7 and/or fluopyram). Inoculation density: 15 000 spores/ml, approx. 33 ml of spore suspension/plant.

The disease level of the plants was evaluated 10 days after the inoculation with Botrytis cinerea.

TABLE 2

| | | | | | | | | | | | | | Disease level |
|---|---|---|---|---|---|---|---|---|---|---|---|---|---|
| | | | 10 d post-inoculation | | | | | | | | | | and shed |
| No. | Treatments | Evaluation | 1 | 2 | 3 | 4 | 5 | 6 | 7 | 8 | 9 | Ø | leaves |
| 1 | Untreated | Disease | 2 | 2 | 5 | 4 | 3 | 4 | 3 | 4 | 3 | 3 | 60 |
| | control, | level | 0 | 0 | 0 | 0 | 0 | 0 | 0 | 0 | 0 | 3 | |
| | inoculated | Shed leaves | 2 | 3 | 3 | 3 | 2 | 2 | 4 | 2 | 3 | 2 | |
| | | | 0 | 0 | 0 | 0 | 0 | 0 | 0 | 0 | 0 | 7 | |
| 2 | Compound I-34 | Disease | 3 | 2 | 4 | 2 | 2 | 4 | 3 | 5 | 2 | 3 | 61 |
| | 5 d before | level | 0 | 0 | 0 | 0 | 0 | 0 | 0 | 0 | 0 | 0 | |
| | inoculation | Shed leaves | 3 | 4 | 4 | 4 | 5 | 3 | 2 | 3 | 0 | 3 | |
| | | | 0 | 0 | 0 | 0 | 0 | 0 | 0 | 0 | | 1 | |
| 3 | Compound I-34, | Disease | 1 | 2 | 5 | 5 | 5 | 3 | 5 | 5 | 3 | 7 | 7 |
| | 5 d before | level | 0 | 0 | | | | | | | | | |
| | inoculation, | Shed leaves | 0 | 0 | 0 | 0 | 0 | 0 | 0 | 0 | 0 | 0 | |
| | fluopyram, | | | | | | | | | | | | |
| | 5 d before | | | | | | | | | | | | |
| | inoculation | | | | | | | | | | | | |
| 4 | Compound I-34, | Disease | 1 | 5 | 5 | 5 | 3 | 3 | 5 | 2 | 3 | 7 | 7 |
| | 10 d before | level | 0 | | | | | | | 0 | | | |
| | inoculation, | Shed leaves | 0 | 0 | 0 | 0 | 0 | 0 | 0 | 0 | 0 | 0 | |
| | fluopyram, | | | | | | | | | | | | |
| | 5 d before | | | | | | | | | | | | |
| | inoculation | | | | | | | | | | | | |
| 5 | Compound I-7, | Disease | 3 | 3 | 3 | 4 | 3 | 3 | 5 | 3 | 2 | 3 | 68 |
| | 5 d before | level | 0 | 0 | 0 | 0 | 0 | 0 | 0 | 0 | 0 | 2 | |
| | inoculation | Shed leaves | 3 | 4 | 2 | 5 | 5 | 1 | 3 | 5 | 6 | 3 | |
| | | | 0 | 0 | 0 | 0 | 0 | 0 | 0 | 0 | 0 | 6 | |
| 6 | Compound I-7, | Disease | 5 | 3 | 5 | 1 | 3 | 5 | 5 | 2 | 3 | 7 | 7 |
| | 5 d before | level | | | | 0 | | | | 0 | | | |
| | inoculation, | Shed leaves | 0 | 0 | 0 | 0 | 0 | 0 | 0 | 0 | 0 | 0 | |
| | fluopyram, | | | | | | | | | | | | |
| | 5 d before | | | | | | | | | | | | |
| | inoculation | | | | | | | | | | | | |
| 7 | Compound I-7, | Disease | 5 | 5 | 5 | 5 | 1 | 1 | 5 | 5 | 3 | 6 | 6 |
| | 10 d before | level | | | | | 0 | 0 | | | | | |
| | inoculation, | Shed leaves | 0 | 0 | 0 | 0 | 0 | 0 | 0 | 0 | 0 | 0 | |
| | fluopyram, | | | | | | | | | | | | |
| | 5 d before | | | | | | | | | | | | |
| | inoculation | | | | | | | | | | | | |
| 8 | Fluopyram, | Disease | 5 | 1 | 5 | 3 | 1 | 1 | 3 | 5 | 2 | 1 | 11 |
| | 5 d before | level | | 0 | | 0 | 0 | 0 | | | 0 | 1 | |
| | inoculation | Shed leaves | 0 | 0 | 0 | 0 | 0 | 0 | 0 | 0 | 0 | 0 | |

Plants which, prior to inoculation with Botrytis cinerea, had been pretreated with a combination of compound I-34 and fluopyram or compound I-7 and fluopyram showed a lower disease level 10 d post-inoculation than plants which had been pretreated with compound I-34 or I-7 only or with fluopyram only. The effect of pre-treatment with the enaminocarbonyl compounds in combination with fluopyram is particularly pronounced with regard to the symptoms of the disease caused by Botrytis cinerea. An active progression of the fungal disease after inoculation with Botrytis cinerea is usually characterized by leaf spots on the plant tissue which are wet and darker in colour. Infected leaf tissue of plants which had been pretreated with the enaminocarbonyl compounds in combination with fluopyram, in contrast, is brownish in colour and dry 10 d post-inoculation (FIGS. 5 and 6), while leaf tissue of inoculated plants which had been pretreated with fluopyram only remains dark and wet (FIG. 4).

### Example 2

### Root Growth Test of Wheat Under Oxygen Deficiency Conditions in the Nutrient Solution

To prepare a suitable solution of the preparation, I part by weight of formulated product is mixed with water to give the desired concentration.

Wheat kernels (Triticum aestivum ‘Dekan’) are sown in compost and grown under suitable climatic conditions in a floating box provided with the solution of the preparation. The nutrient solution of the floating box was not aerated (oxygen deficiency stress).

After the desired period of time, the maximum length of the root per wheat plant is measured, and the average root length per floating box and treatment is calculated.

In this test, it emerged that the compound according to the invention outperforms the control:

TABLE 3
Root growth of wheat

| | Concentration | Length |
|---|---|---|
| Active substance | in mg a.i./plant | in cm after 14 d |
| Compound (I-7) | 0.5 | 22.1 |
| Control | | 15.9 |

### Example 3

### Root Growth Test of Tomatoes Under Oxygen Deficiency Conditions in the Nutrient Solution

To prepare a suitable solution of the preparation, I part by weight of active substance is mixed with water to give the desired concentration.

Tomato seeds (Solanum lycopersicum ‘Rentita’) are grown in rock wool. After germination, the rock wool blocks are transferred into a floating box provided with the solution of the preparation and grown on under suitable climatic conditions.

The nutrient solution of the floating box was not aerated (oxygen deficiency stress).

After the desired period of time, the maximum length of the root per tomato plant is measured, and the average root length per floating box and treatment is calculated.

In this test, it emerged that the compounds according to the invention outperform the control:

TABLE 4
Root growth of tomatoes

| | Concentration | Length |
|---|---|---|
| Active substance | in mg a.i./plant | in cm after 12 d |
| Compound (I-7) | 1.0 | 8.67 |
| Compound (I-34) | 1.0 | 9.53 |
| Compound (I-25) | 1.0 | 9.19 |
| Compound (I-31) | 1.0 | 11.16 |
| Compound (I-18) | 1.0 | 7.56 |
| Compound (I-6) | 1.0 | 11.08 |
| Compound (I-14) | 1.0 | 6.97 |
| Compound (I-5) | 1.0 | 7.52 |
| Compound (I-8) | 1.0 | 7.43 |
| Control | | 1.88 |

### Example 4

### Leaf Biomass Test on Wheat or Tomatoes Under Oxygen Deficiency Conditions in the Nutrient Solution

To prepare a suitable solution of the preparation, 1 part by weight of formulated product is mixed with water to give the desired concentration.

Wheat kernels (Triticum aestivum ‘Dekan’) or tomato seeds (Solanum lycopersicum ‘Rentita’) are sown in compost and grown under suitable climatic conditions in a floating box provided with the solution of the preparation. The nutrient solution of the floating box was not aerated (oxygen deficiency stress).

After the desired period of time, the leaf biomass per wheat or tomato plant is measured, and the average weight per floating box and treatment is calculated.

In this test, it emerged that the compound according to the invention outperforms the control:

TABLE 5
Leaf biomass of wheat

| | Concentration | Weight |
|---|---|---|
| Active substance | in mg a.i./plant | in g after 22 d |
| Compound (I-7) | 0.5 | 15.7 |
| Control | | 12.8 |

TABLE 6
Leaf biomass of tomato

| | Concentration | Weight |
|---|---|---|
| Active substance | in mg a.i./plant | in g after 21 d |
| Compound (I-7) | 1.0 | 19.4 |
| Control | | 7.8 |

### Example 5

### Shoot Length Test on Tomatoes Under Oxygen Deficiency Conditions in the Nutrient Solution

To prepare a suitable solution of the preparation, 1 part by weight of active substance is mixed with water to give the desired concentration.

Tomato seeds (Solanum lycopersicum ‘Rentita’) are grown in rock wool. After germination, the rock wool blocks are transferred into a floating box provided with the solution of the preparation and grown on under suitable climatic conditions.

The nutrient solution of the floating box was not aerated (oxygen deficiency stress).

After the desired period of time, the maximum shoot length per tomato plant is measured, and the average shoot length per floating box and treatment is calculated.

In this test, it emerged that the compounds according to the invention outperform the control:

TABLE 7
Shoot length of tomatoes

| | Concentration | Length |
|---|---|---|
| Active substance | in mg a.i./plant | in cm after 19 d |
| Compound (I-7) | 1.0 | 7.15 |
| Compound (I-34) | 1.0 | 6.75 |
| Compound (I-25) | 1.0 | 6.8 |
| Compound (I-31) | 1.0 | 6.78 |
| Compound (I-6) | 1.0 | 7.33 |
| Compound (I-8) | 1.0 | 6.6 |
| Control | | 6.28 |

1. A method for enhancing plants' intrinsic defenses and/or for enhancing the resistance of plants to plant diseases which are caused by fungi, bacteria, viruses, mycoplasma-like organisms and/or rickettsia-like organisms, said method comprising treating plants with at least one compound selected from the enaminocarbonyl compounds of formula (I) 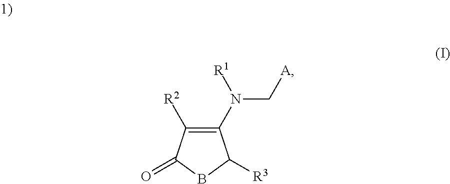
in which
A represents 5,6-difluorpyrid-3-yl; 5-chloro-6-fluoropyrid-3-yl; 5-brom-6-fluoropyrid-3-yl; 5-iodo-6-fluoropyrid-3-yl; 5-fluoro-6-chloropyrid-3-yl; 5,6-dichlorpyrid-3-yl; 5-bromo-6-chloropyrid-3-yl; 5-iodo-6-chloropyrid-3-yl; 5-fluor-6-brom-pyrid-3-yl; 5-chloro-6-brompyrid-3-yl; 5,6-dibrompyrid-3-yl; 5-fluor-6-iodopyrid-3-yl; 5-chloro-6-iodopyrid-3-yl; 5-bromo-6-iodopyrid-3-yl; 5-methyl-6-fluoropyrid-3-yl; 5-methyl-6-chloropyrid-3-yl; 5-methyl-6-bromopyrid-3-yl; 5-methyl-6-iodopyrid-3-yl: 5-difluormethyl-6-fluoropyrid-3-yl: 5-difluormethyl-6-chlorpyrid-3-yl; 5-difluormethyl-6-bromopyrid-3-yl or 5-difluormethyl-6-iodopyrid-3-yl,
B represents oxygen or methylene,
R¹ represents optionally fluorine-substituted C₁-C₅-alkyl, C₂-C₅-alkenyl, C₁-C₅-cycloalkyl, C₃-C₅-cycloalkylalkyl or C₁-C₅-alkoxy,
R² represents hydrogen or halogen and
R³ represents hydrogen or methyl.

2. The method according to claim 1, wherein the at least one enaminocarbonyl compound is selected from the group consisting of
(I-8), 4-{[(6-chloro-5-fluoropyrid-3-yl)methyl](methyl)amino}furan-2(5H)-one
(I-9), 4-{[(5,6-dichloropyrid-3-yl)methyl](cyclopropyl)amino}furan-2(5H)-one
(I-10), 4-{[(5,6-dichloropyrid-3-yl)methyl](methyl)amino}furan-2(5H)-one
(I-11), 4-{[(6-bromo-5-fluoropyrid-3-yl)methyl](methyl)amino}furan-2(5H)-one
(I-12), 4-{[(6-bromo-5-fluoropyrid-3-yl)methyl](cyclopropyl)amino}furan-2(5H)-one
(I-13), 4-{[(6-chloro-5-fluoropyrid-3-yl)methyl](cyclopropyl)amino}furan-2(5H)-one
(I-14), 4-{[(5,6-dichloropyrid-3-yl)methyl](2-fluoroethyl)amino}furan-2(5H)-one
(I-15), 4-{[(5,6-dichloropyrid-3-yl)methyl](2-fluoroethyl)amino}furan-2(5H)-one
(I-16), 4-{[(6-bromo-5-fluoropyrid-3-yl)methyl](2,2-difluoroethyl)amino}furan-2(5H)-one and (I-17), 4-{[(6-chloro-5-fluoropyrid-3-yl)methyl](2,2-difluoroethyl)amino}furan-2(5H)-one.

3. The method according to claim 1, wherein the plant treated with the at least one enaminocarbonyl compound is transgenic.

4. The method according to claim 1, wherein the plant is protected from biotic or abiotic stress factors by the treatment.

5. The method according to claim 1, wherein the at least one enaminocarbonyl compound is used in combination with at least one fertilizer.

6. A method for protecting seed and germinating plants, for enhancing the plants' intrinsic defences and/or for improving plant growth and/or for increasing the resistance of plants to plant diseases which are caused by fungi, bacteria, viruses, mycoplasma-like organisms and/or rickettsia-like organisms said method comprising treating the seed or germinating plant with at least one compound selected from the class of the enaminocarbonyl compounds of formula (I) 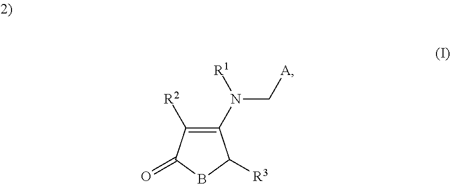
in which
A represents 5,6-difluorpyrid-3-yl; 5-chloro-6-fluoropyrid-3-yl; 5-brom-6-fluoropyrid-3-yl; 5-iodo-6-fluoropyrid-3-yl; 5-fluoro-6-chloropyrid-3-yl; 5,6-dichlorpyrid-3-yl; 5-bromo-6-chloropyrid-3-yl; 5-iodo-6-chloropyrid-3-yl: 5-fluor-6-brom-pyrid-3-yl: 5-chloro-6-brompyrid-3-yl; 5,6-dibrompyrid-3-yl; 5-fluor-6-iodopyrid-3-yl; 5-chloro-6-iodopyrid-3-yl; 5-bromo-6-iodopyrid-3-yl; 5-methyl-6-fluoropyrid-3-yl; 5-methyl-6-chloropyrid-3-yl; 5-methyl-6-bromopyrid-3-yl; 5-methyl-6-iodopyrid-3-yl; 5-difluormethyl-6-fluoropyrid-3-yl; 5-difluormethyl-6-chlorpyrid-3-yl; 5-difluormethyl-6-bromopyrid-3-yl or 5-difluormethyl-6-iodopyrid-3-yl,
B represents oxygen or methylene,
R¹ represents optionally fluorine-substituted C₁-C₅-alkyl, C₂-C₅-alkenyl, C₃-C₅-cycloalkyl, C₃-C₅-cycloalkylalkyl or C₁-C₅-alkoxy,
R² represents hydrogen or halogen and
R³ represents hydrogen or methyl.

7. The method according to claim 6, wherein a nutrient solution is used for the treatment of the seed and/or the germinating plant in which an amount of from 0.0005 to 0.025% by weight of at least one enaminocarbonyl compound based on the total weight of the nutrient solution is present.

8. The method according to one of claim 6, wherein the plants are grown in a floating method.

9. A nutrient solution for growing plants and/or germinating plants, comprising an amount of at least one enaminocarbonyl compound that it is effective for enhancing plants' intrinsic defences and/or for improving plant growth and/or for enhancing the resistance of plants to plant diseases which are caused by fungi, bacteria, viruses, mycoplasma-like organisms and/or rickettsia-like organisms, wherein the at least one enaminocarbonyl compound is a selected from the group consisting of the compounds of formula (I) 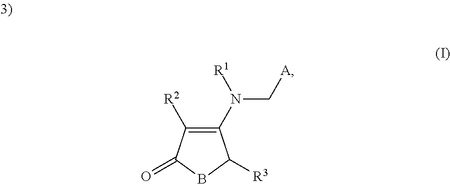
in which
A represents 5,6-difluorpyrid-3-yl; 5-chloro-6-fluoropyrid-3-yl; 5-brom-6-fluoropyrid-3-yl; 5-iodo-6-fluoropyrid-3-yl; 5-fluoro-6-chloropyrid-3-yl; 5,6-dichlorpyrid-3-yl; 5-bromo-6-chloropyrid-3-yl; 5-iodo-6-chloropyrid-3-yl; 5-fluor-6-brom-pyrid-3-yl; 5-chloro-6-brompyrid-3-yl; 5,6-dibrompyrid-3-yl; 5-fluor-6-iodopyrid-3-yl: 5-chloro-6-iodopyrid-3-yl; 5-bromo-6-iodopyrid-3-yl; 5-methyl-6-fluoropyrid-3-yl; 5-methyl-6-chloropyrid-3-yl; 5-methyl-6-bromopyrid-3-yl; 5-methyl-6-iodopyrid-3-yl; 5-difluormethyl-6-fluoropyrid-3-yl; 5-difluonnethyl-6-chlorpyrid-3-yl; 5-difluormethyl-6-bromopyrid-3-yl or 5-difluormethyl-6-iodopyrid-3-yl,
B represents oxygen or methylene,
R¹ represents optionally fluorine-substituted C₁-C₅-alkyl, C₂-C₅-alkenyl, C₃-C₅-cycloalkyl, C₃-C₅-cycloalkylalkyl or C₁-C₅-alkoxy,
R² represents hydrogen or halogen and
R³ represents hydrogen or methyl.

10. The nutrient solution according to claim 9, wherein the content of the at least one enaminocarbonyl compound in the nutrient solution amounts to from 0.0005 to 0.025% by weight based on the total weight of the nutrient solution.

11. A method of enhancing plants' intrinsic defences and/or for improving plant growth and/or for enhancing the resistance of plants to plant diseases which are caused by fungi, bacteria, viruses, mycoplasma-like organisms and/or rickettsia-like organisms comprising treating the plant with a nutrient solution as claimed in claim 9.

12. The method for growing plants from propagation material, comprising seed, said method comprising using a nutrient solution according to claim 9.

13. A method for inducing PR proteins in a plant comprising applying at least one compound selected from the class of the enaminocarbonyl compounds to said plant, wherein the at least one enaminocarbonyl compound is selected from the group consisting of the compounds of formula (I) 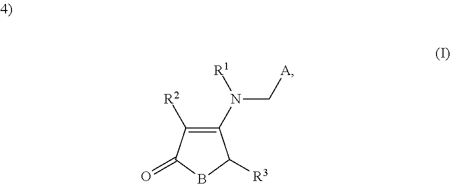
in which
A represents 5,6-difluorpyrid-3-yl; 5-chloro-6-fluoropyrid-3-yl; 5-brom-6-fluoropyrid-3-yl; 5-iodo-6-fluoropyrid-3-yl; 5-fluoro-6-chloropyrid-3-yl; 5,6-dichlorpyrid-3-yl; 5-bromo-6-chloropyrid-3-yl; 5-iodo-6-chloropyrid-3-yl; 5-fluor-6-brom-pyrid-3-yl; 5-chloro-6-brompyrid-3-yl; 5,6-dibrompyrid-3-yl; 5-fluor-6-iodopyrid-3-yl; 5-chloro-6-iodopyrid-3-yl: 5-bromo-6-iodopyrid-3-yl: 5-methyl-6-fluoropyrid-3-yl; 5-methyl-6-chloropyrid-3-yl; 5-methyl-6-bromopyrid-3-yl: 5-methyl-6-iodopyrid-3-yl; 5-difluormethyl-6-fluoropyrid-3-yl; 5-difluormethyl-6-chlorpyrid-3-yl; 5-difluormethyl-6-bromopyrid-3-yl or 5-difluormethyl-6-iodopyrid-3-yl,
B represents oxygen, or methylene,
R¹ represents optionally fluorine-substituted C₁-C₅-alkyl, C₂-C₅-alkenyl, C₁-C₅-cycloalkyl, C₃-C₅-cycloalkylalkyl or C₁-C₅-alkoxy,
R² represents hydrogen or halogen and
R³ represents hydrogen or methyl.

14. The method according to claim 1, wherein the plants are selected from the group consisting of turf, vines, cereals, beet, fruits, legumes, oil crops, cucurbits, fibre plants, citrus fruit, vegetables, Lauraceae, Cinnamomum, camphor, tobacco, nuts, coffee, aubergine, sugarcane, tea, pepper, grapevines, hops, bananas, latex plants, ornamentals, shrubs, deciduous trees and coniferous trees.
